(19) United States
(12) Patent Application Publication
(10) Pub. No.: US 2002/0099799 A1
(43) Pub. Date: Jul. 25, 2002

(54) Method and system for universal and transparent access to heterogeneous resources

(76) Inventor: Amir D. Kolsky, Binyamina (IL)

Correspondence Address: KENYON & KENYON, ONE BROADWAY, NEW YORK, NY, 10004, US

(21) Appl. No.: 09/885,628

(22) Filed: Jun. 19, 2001

Related U.S. Application Data
(60) Provisional application No. 60/212,628, filed on Jun. 19, 2000.

(51) Int. Cl. G06F 15/16

(52) U.S. Cl. 709/219

(57) ABSTRACT

The present invention provides a method and system for universal and transparent access to resources residing on heterogeneous networks. A universal transparent identifier is associated with desired resources residing on the heterogeneous networks. A universal resource resolving network is deployed within each heterogeneous network. The resolving network function to resolve universal resource identifiers and initiate a communications session with the desired resource.

### RELATED PROVISIONAL APPLICATION

The present application claims the benefit of U.S. Provisional Patent Application entitled System And Method For Object Access, filed on 60/212,628, application number filed on Jun. 19, 2000.

### FIELD OF THE INVENTION

The present invention relates to the areas of telecommunication and information networks. In particular, the present invention provides a method and system for allowing universal access to heterogeneous resources via an access network and access network device utilizing an associated access method.

### BACKGROUND INFORMATION

In recent years the diversity and functionality of telecommunication networks has evolved dramatically into a landscape of heterogeneous networks each being associated with a diverse array of heterogeneous resources. In particular, the diversity of available resources and the associated networks on which the reside eclipses the notion of a single traditional voice communications network utilizing circuit switching such as the PSTN (“Public Switched Telephone Network”). Instead, the PSTN emerges as merely one network entity amidst a sea of heterogeneous networks. Today the functionality of telecommunications extends far beyond a simple notion of point-to-point voice calls to the concept of a complex structure of heterogeneous information networks each being associated with a myriad of resources.

Moreover, information network users are equipped with a variety of access devices that may support various capabilities including voice, audio, data and text, as well as multimedia capabilities. Some of these devices may support multi-mode communications, which allow, for example data access as well as voice communications (e.g., recent introduction of cellular telephones with WWW access).

Furthermore, modem telecommunications users have come to rely on the services and functionality provided by these diverse information networks. For example, today users depend on the Internet and WWW (“World Wide Web”) as heavily as they have on the PSTN.

However, despite the enhanced potential of modern communications networks, access to resources is often restricted in that a user must access a particular resource utilizing an information network with which that resource is associated. Thus, for example, if a user desires to access a WWW page, the user must utilize an access device that connects to the Internet and WWW. Similarly, to dial a telephone number, a user must utilize an access device that connects to the PSTN. Moreover, in order to access a particular resource, a user must be equipped with an access device that can communicate utilizing the protocols and access methods associated with the resource. Furthermore, users are required to be fluent in a myriad of network protocols and network addressing schemes. For example, if a user desires to access a resource on the Internet, the user must remember a particular URL associated with the resource. On the other hand, using the PSTN, the user must remember a particular telephone number associated with a resource. Resources are associated with networks in that they are accessible only via certain networks.

Each available information network is associated with a particular access method and access device. For example, the PSTN relies upon a telephone access device. Users access resources through an access method of dialing a telephone number associated with a desired resource. On the other hand, when utilizing a network such as the Internet and WWW users are forced to adapt to the idiosyncratic access methods associated with the WWW (i.e., a browser and HTTP (“Hypertext Transport Protocol”)) in order to access resources associated with the Internet WWW. In addition, users take for granted that they are forced to rely upon a specific access device (typically a computer), which carries its own intrinsic interaction mechanism (typically a keyboard and mouse). Although, WWW enabled wireless telephones have been introduced, these devices are essentially multimode devices that incorporate a wireless telephone with a processor running a WWW browser. With these devices, users are nevertheless required to adapt to the WWW environment and associated access methods (i.e., a browser and HTTP).

The evolving nature of telecommunication networks has resulted in a growing reliance by modern telecommunications users rely upon access to a diverse and flexible variety of resources in order to effectively work and communicate. Resources may include data, processes and services, methods for access to information etc. The concept of a resource as it relates to modem information networks is constantly evolving and only limited by the imagination of network architects and telecommunication engineers. Thus, for example, resources may include new types of data and media accessible to users, which may have been inaccessible using conventional telecommunication networks such as the PSTN including video or still frame images.

FIG. 1 depicts a relationship between a number information networks and corresponding access devices. In particular, FIG. 1 depicts information networks 112(1)-112(N), each of which may respectively be accessed via corresponding network interface 120(1)-120(N) and network device 102(1)-102(N). Note, although FIG. 1 depicts only a single access device 102 per information network 112, each information network 112(1)1 112(N) may be associated with a plurality of network devices for accessing resources on the network.

Referring to FIG.1, information network 112(1) (which might be the PSTN, for example) is associated with network interface 120(1) (which might be an SSP node) and network device 102(1) (which might be, for example, a conventional telephony device). Information network 112(2) (which might be the Internet/WWW, for example) is associated with network interface 120(2) (which might be an ISP) and network device 102(2) (which might be a computing device such as a personal computer). Similarly, access networks 112(3)-112(N) are accessible via corresponding network interfaces 120(3)-120(N) and access devices 102(3)-102(N). Note that each information network 112(1)-112(N) is respectively associated with a plurality of resources, 105(11)-105(1N) 105(N1)-105(NN). Resources are typically associated with a network by virtue of being accessible via that network. That is, with known methods and systems, resources are deemed to be available or accessible via particular networks and associated network protocols. For example, HTML pages are typically associated with the Internet/WWW, by virtue of the fact that users typically access HTML pages via protocols associated with the Internet/WW (namely, HTTP and TCP/IP). Effectively, information networks 112(1)-112(N) respectively function as access networks for resources associated with those networks (i.e., resources 105(12)-105(1N)-105(N1)-105(NN)) in that these networks allow a user to access those respective resources.

Using conventional technology, a user may only access those resources associated with a network that is associated with the particular desired resources (i.e., the associated network effectively function as an access network). For example, in the case where the network is the PSTN with an associated network device of a telephone device, typically a telephone may only obtain access to physical or virtual voice communication channels (in some cases circuit switched, in other packet based) within the PSTN. With known methods, access to an HTML page residing on an WWW server would not be possible via, for example, the PSTN using a telephone.

Although multimode access devices do exist (e.g., a WAP enabled cellular telephone), which may provide access to resources on heterogeneous networks (i.e., the PSTN and the Internet/WWW), to access resources associated with different networks requires utilization of an access method and network address for the resource that is specific to the particular network being accessed. For example, if a user of a WAP enabled telephone desires to initiate a WAP session with a desired resource such as an HTML page on the Internet/WWW, the user must first switch the cellular phone into a WAP/data mode. Then, the user must enter a URL associated with the HTML page using the HTTP protocol. There does not exist a universal mechanism for access to resources associated with heterogeneous networks from any network.

FIG. 2 is a block diagram of elements within an SS7 network. In particular, FIG. 2a depicts two interconnected SS7 networks 214(1) and 214(2). SS7 networks 214(1)-214(2) may include one or more of the following elements SSP (“Signaling Switching Points”) 201(1)-201(4) nodes, STP (“Signaling Transfer Point”) 212(1)-212(4) nodes and SCP (“Signaling Control Point”) nodes 202(1)-202(4). Note that the exemplary SS7 networks 214(1)-214(2) shown in FIG. 2a depicts four SSP nodes 201(1)-201(4), four STP nodes 212(1)-212(4) and four SCP nodes 202(1)-202(4). However, an SS7 network may include any number or combination of these elements. SSP nodes 201(1)-201(4) are telephone switches (end offices or tandems) equipped with SS7-capable software and terminating signaling links. SSP nodes 201(1)-201(4) originate, terminate or switch calls. STPs 212(1)-212(4) provide packet switching function, receiving and routing incoming signaling messages toward a proper destination as well as specialized routing function. SCP nodes 202(1)-202(4) are databases that provide information necessary for advanced call-processing capabilities. Note that SSP nodes 201(1)-201(4), STP nodes 212(1)-212(4) and SCP nodes 202(1)-202(4) are coupled together via signaling links 243. SSP nodes 201(1)-201(4) are coupled together via voice trunks 245.

FIG. 2 also depicts a plurality of access devices 102(1)-102(6), in this case telephony devices, that are coupled to SSP nodes 201(1)-201(4) via subscriber lines 247.

### SUMMARY OF THE INVENTION

The present invention provides a method and system for universal access to resources associated with any information network through any other information network and network device. Resources are associated with a universal transparent resource identifier (“UTRI”) that provides an immutable signifier for accessing a particular resource via any information network. According to the present invention, access to resources is provided transparently such that a user may initiate a communications session with a resource utilizing a known information network (e.g., the PSTN) using an associated network device (e.g., telephone) in a conventional manner (e.g., by dialing) even where the desired resource is associated with an external information network (e.g., the Internet and WWW) and is typically accessed with a network addressing scheme foreign to that of the PSTN. In general, the desired resources may be associated with information networks, which are external to the information network serving as access network or the resources may be associated with the information network serving as the access network itself.

According to the present invention, resources associated with diverse heterogeneous networks are each assigned a constant and immutable universal identifier, which operates transparently to provide access to the particular resource via any information network. According to the present invention, a URP (“UTRI Resolving Point”) network is deployed transparently so that is accessible to one or more information networks either by utilizing existing infrastructure or by retrofitting an information network with special purpose hardware and software. A URP network includes one or more URP nodes, which individually or collectively provide functionality for: (1) resolving UTRI requests generated by an access device via any information network to determine a corresponding resource; (2) initiate a communications session between the desired resource and the access device. According to one embodiment, a URP node may also perform a communications decision process for determining a particular communications mode with which to establish a communications session between the desired resource and the access device. According to one embodiment, this is accomplished by receiving an identifier parameter relating to an access device making a particular UTRI request. A database storing an association between a plurality of access devices and corresponding communication capabilities is then searched to determine the communications capabilities of the access device (i.e., PSTN telephony, WAP, etc.). This communications capabilities information may include additional information such as display capabilities, bandwidth, etc associated with the access device. The communications mode decision process then determines a best communications mode between the user and the resource. According to one embodiment, this is accomplished by consulting a pre-defined user profile of desired communication modes.

According to one embodiment of the present invention, the PSTN functions as an access network such that users may access resources utilizing an UTRI which are associated with the PSTN itself or are associated with information networks external to the PSTN. Thus, for example, users may utilize a conventional telephone and the PSTN to access heterogeneous resources, which may be associated with networks external to the PSTN such as on the Internet and which are normally inaccessible via access methods associated with the PSTN (dialing).

The present invention provides a method and system for establishing access to a resource by a telephony user. According to the present invention, a telephony user may establish access to a resource using a telephony device in a manner transparent to an underlying telephony network and protocol such as the PSTN. Resources may include data or services of any form including text, video audio, commerce, information services, etc. According to the present invention, a telephony user may access a desired resource by dialing an identifier on a telephony device herein referred to as a UTRI, which is a special form of a UTRI associated with a desired resource in a manner familiar to the dialing of a particular party using a conventional telephony network and telephony device. However, using the present invention, rather than establishing communications with a particular party, the dialing of a URTDI establishes access by the telephony user to the desired resource. The present invention provides significant advantages and extensions to the conventional telephony network by facilitating access to resources using a flexible and customizable addressing scheme accessed using a traditional telephony device.

According to one embodiment of the present invention, a unique URTDI is associated with each of at least one resource. Assignment of UTRIs to particular resources may be customized and provides significant flexibility beyond the ten digit numeric code associated with telephony networks such as the PSTN. In particular, according to the present invention UTRIs provide an addressing and access scheme for associated data objects, which are accessed using a conventional telephony device such as a telephony set.

Resources may include one or more methods for performing communications functions utilizing any number of communications methods including voice, data, IVR (“Interactive Voice Response”), FAX, etc. Resources may reside in any distributed fashion throughout an information network such as a resource node, which is coupled to a conventional telephony network. According to one embodiment, the data object node itself is part of a communication network external to the telephony network.

According to one embodiment, a telephony user desiring to access a resource dials an access code and a UTRI using a conventional telephony device. The access code and UTRI are processed and appropriate switching and signaling operations performed to provide access to the telephony user of the desired resource.

### BRIEF DESCRIPTION OF THE DRAWINGS

FIG. 1 depicts a relationship between a number information networks and corresponding access devices.

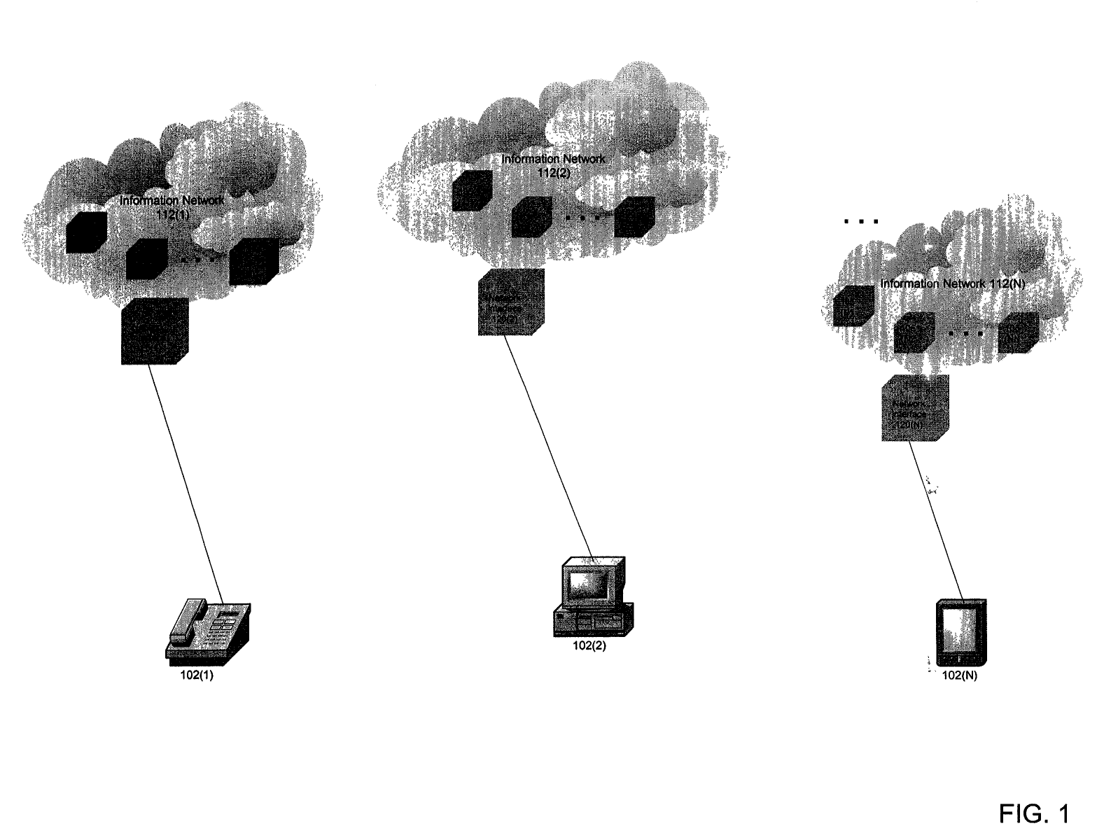

FIG. 2 is a block diagram of elements within an SS7 network.

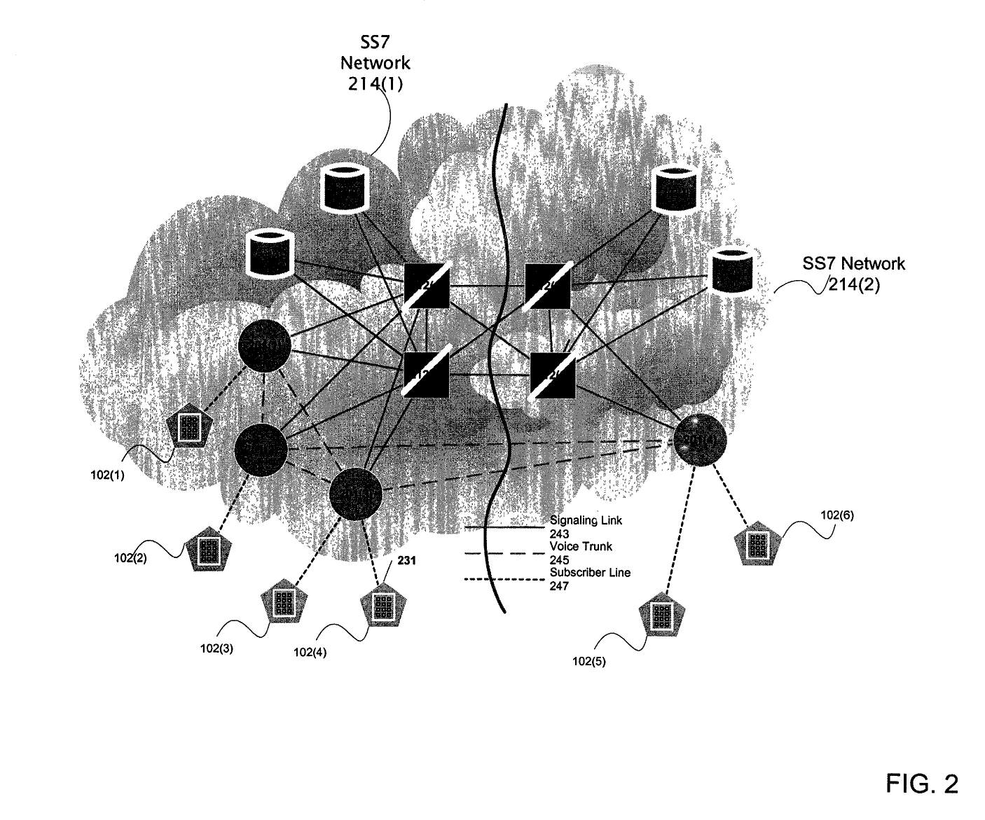

FIG. 3 is a block diagram depicting an overall operation of the present invention according to one embodiment of the present invention.

FIG. 4 is a block diagram that depicts a relationship between a plurality of heterogeneous information networks and a plurality of URP networks according to one embodiment of the present invention.

FIG. 5 depicts a scheme for universal access to a resource via any number of access networks according to one embodiment of the present invention.

FIG. 6 depicts the operation of a UTRI according to one embodiment of the present invention.

FIG. 7 depicts the relationship between a UTRI and a signaling prefix code according to one embodiment of the present invention.

FIG. 8 depicts a structure of a URP node according to one embodiment of the present invention.

FIG. 9 depicts a number of data structures stored in a database at a URP node according to one embodiment of the present invention.

FIG. 10a is a flowchart that depicts a number of exemplary steps for performing a UTRI resolution process according to one embodiment of the present invention.

FIG. 10b is a flowchart of a session establishment process performed by a URP node according to one embodiment of the present invention.

FIG. 10c is a flowchart depicting a series of steps for a communications decisions process performed by a URP node according to one embodiment of the present invention.

FIG. 11a is a network diagram a method for performing a user-initiated session initialization process according to one embodiment of the present invention.

FIG. 11b is a network diagram a method for performing a resource-initiated session initialization process according to one embodiment of the present invention.

FIG. 12c is a network diagram a method for performing a third-party-initiated session initialization process according to one embodiment of the present invention.

FIG. 12 is a block diagram illustrating the integration of a URP network into the PSTN in order to provide universal resource access according to one embodiment of the present invention.

FIG. 13 depicts an exemplary network configuration for establishing a PSTN communication channel with a resource associated with the PSTN according to one embodiment of the present invention.

FIG. 14 depicts an exemplary scenario for establishing a WAP communication session according to one embodiment of the present invention.

FIG. 15 depicts an exemplary scenario for establishing an e-mail communication according to one embodiment of the present invention.

FIG. 16 is a block diagram depicting an operation of a universal shell object according to one embodiment of the present invention.

### DETAILED DESCRIPTION

The present invention provides a method and system to allow any user connecting via any information network 112 and access device 102 to access resources residing on heterogeneous networks 112(1)-112(N).

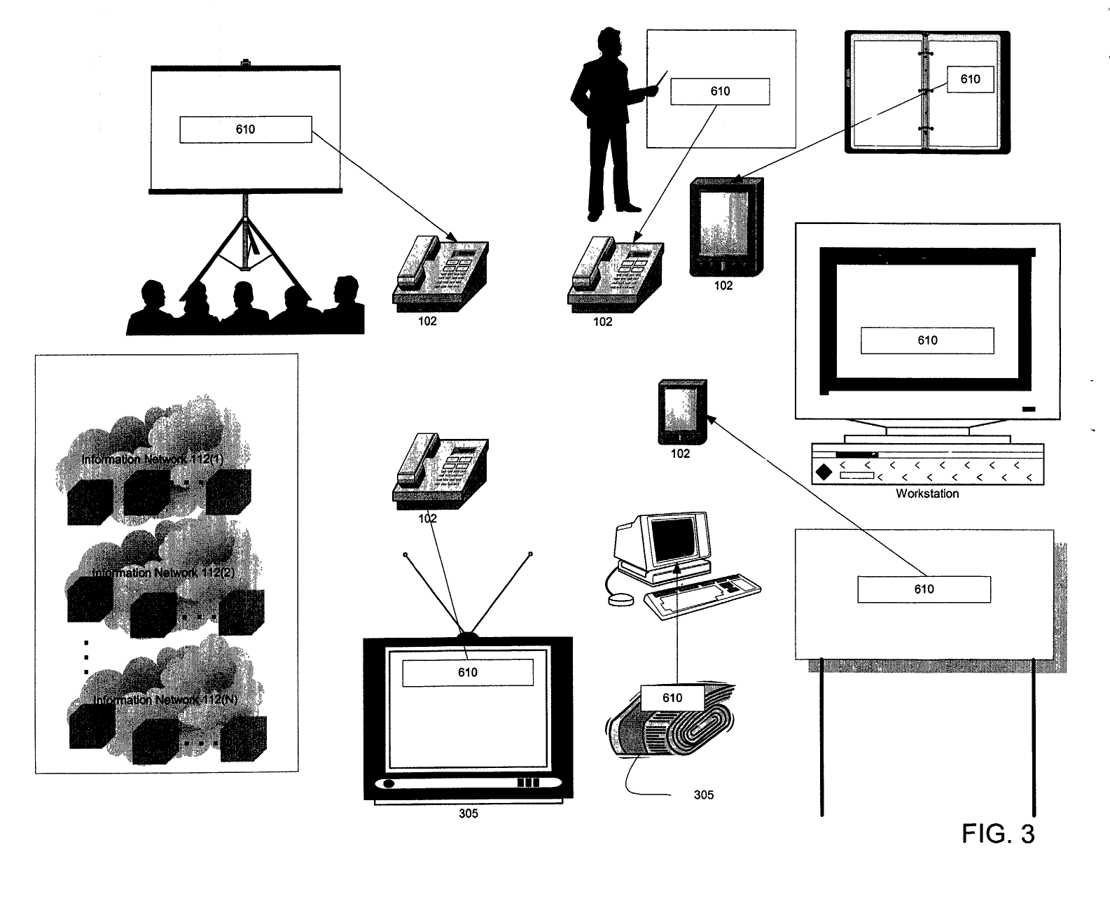

FIG. 3 is a block diagram depicting an overall operation of the present invention according to one embodiment of the present invention. Users (not shown) utilizing a plurality of heterogeneous information networks 112(1)-112(N), each associated with a plurality of respective resources 105(11)-105(1N)-105(N1)-105(NN) and associated access devices 102. Users utilizing any information network 112 desire to initiate a communication session with any resource 105, regardless of a particular network association. For example, information network 112(1) may be the PSTN, and information network 112(2) may be the Internet WWW. Users of the PSTN may also desire to access resources associated with Internet/WWW (e.g., 112(2)) utilizing an access device 102 associated with the PSTN (i.e., a telephone). Similarly, users of the Internet/WWW network may typically desire to access resources associated with the PSTN utilizing an access device associated with the Internet/WWW (i.e., a CPU running browser software). Furthermore, it is desirable to provide a universal and transparent method for resource access, independent of the information network from which access is sought.

According to the present invention, a UTRI 610 is associated with each resource 105. A UTRI 610 is universal in that it signifies a particular resource independent of the information network from which access is sought. According to the present invention, a delivery mechanism is provided for disseminating UTRIs to potential users. A UTRI is disseminated to users utilizing various delivery mechanisms 305 including but not limited to television, radio, newspaper articles, advertisements, classified ads, business documents, books and magazines, billboards, music videos, currency, labels, cinema and movie presentations the Internet and WWW, banners, etc. The possible types of delivery mechanisms for UTRIs are virtually inexhaustible. For example, UTRIs may be embedded in any type of commercial product to provide a mechanism for users of the product to access critical information related to the product. For example, if the product were a medication, a UTRI could be embedded on the label of the application such that when submitted by a user, information related to the medication would be available to the user using a variety of access devices. A UTRI could even be embedded on a capsule or pill through which the medication is packaged and dispensed. For example, UTRIs may be placed on printed materials, that when contacted can provide a selection of services available for that printed article, in effect enabling interactive printed matter, such as interactive articles, interactive classifieds, interactive advertisements and interactive yellow pages. Users may initiate a communications session by inputting the UTRI 610 into a respective access device 102 associated with an information network 112. The UTRI is transmitted to a URP network (described in detail below), which functions to resolve the UTRI to identify an associated resource and establish a communications session with the resource 105.

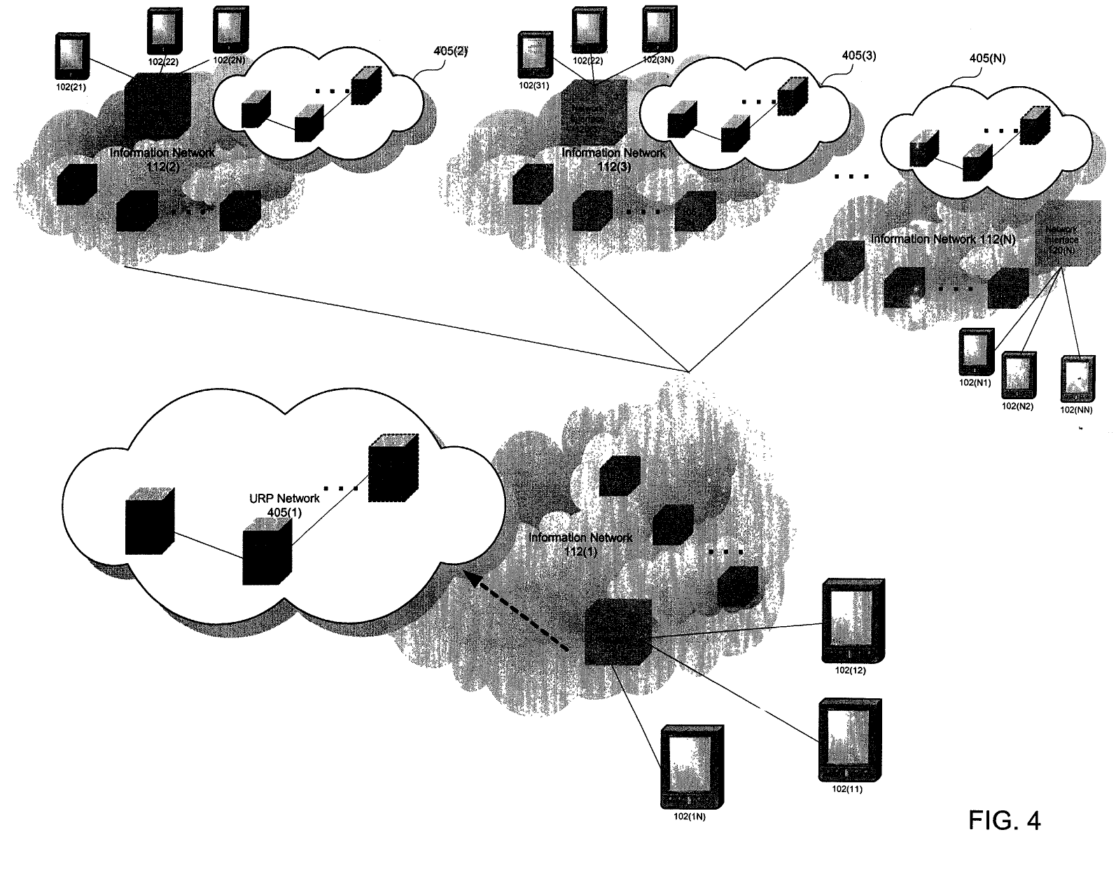

FIG. 4 is a block diagram that depicts a relationship between a plurality of heterogeneous information networks and a plurality of URP networks according to one embodiment of the present invention. Information networks 112 may include any type of telecommunications network including the PSTN, the Internet and WWW, an ISDN (“Integrated Services Digital Network”) network, IP telephony network, wireless networks, a pager network, a wide area network, a metropolitan area network (“MAN”), a private network (e.g., a LAN) or even networks not yet implemented, etc. Heterogeneous information networks 112(1)-112(N) are associated with distinct communication protocols, access methods, switching and signaling schemes, etc.

Each information network is associated with an arbitrary number of resources 105. The types of resources associated with each heterogeneous network 112(1)-112(N) will vary depending upon the type of network. For example, assuming network 112(1) were the PSTN, available resources associated with that network will typically include voice communication bandwidth associated with a particular node on the network (typically a phone number associated with a user). Similarly, resources might also include a FAX communication bandwidth associated with a particular node on the PSTN. Other resources available on the PSTN or general telephony network might include IVR functionality utilizing an IVR server. On the Internet and WWW, resources will typically include HTML pages residing on servers throughout the network, media streams including audio and video information, e-mail services utilizing associated e-mail protocols such as SMTP (“Simple Mail Transport Protocol”), POP3 (“Post Office Protocol”) and or IMAP (“Internet Message Access Protocol”).

Furthermore each information network 112 and associated access device 102 is associated with a corresponding access method. For example, for the PSTN and an associated a telephony device 102, a corresponding access method is dialing a telephone number. For the Internet and an associated computing device running browser software, a corresponding access method is typing a URL into a browser or clicking on an HTML hyperlink.

Other types of heterogeneous networks may include networks based on a peer-to-peer model rather than a client-server model.

Information networks 112(1)-112(N) are respectively associated with access devices 102 for performing operations with these networks including initiating connections via signaling operations, retrieving and transmitting information etc. Each access device 102 provides functionality for connecting to and communicating utilizing appropriate protocols to perform various operations with respect to particular information networks 112 including initiating connections (via signaling), transmitting and receiving analog and digital data, etc.

In general, access device 102 may be any device designed to operate in conjunction with a particular information network 112 (i.e., to initiate sessions on the information network 112, to access resources residing on the network 112, etc). Typically, each access device 102 includes hardware and software to perform communications with a particular network infrastructure to perform session set-up (in a connection-oriented protocol) as well as session tear-down via signaling protocols. Furthermore, each of the information networks 112 depicted in FIG. 4 may be a circuit-switched or packet network. As shown in FIG. 4, users (not shown) utilize respective access devices 102(11)-102(1N), 102(21)-102(2N) through 102(N1)-102(NN) to connect to respective information networks 112(1)-112(N) via respective network interfaces 120(1)-120(N).

For example, for the PSTN, a conventional telephone device would function as an access device 102. However, other devices may serve as access devices for the PSTN including FAX machines, etc. On the PSTN, a telephone provides functionality for generating signaling codes (via DTMF (“Dual Tone Multi-Frequency”)) to initiate a PSTN connection with an entity (e.g., a person) at some endpoint on the PSTN. Note that some access devices 102 may be capable of communicating with more than one information network 112, for example, a WAP (“Wireless Access Protocol”) enabled telephone that may communicate utilizing WAP, for example, to establish an HTTP session on the Internet and WWW. Furthermore, some access devices 102 may include functionality for dual-mode communication utilizing both analog and digital communication techniques with a single or multiple networks as well as functionality for mode switching from a packet mode (e.g., data mode) to a circuit-switched mode. Moreover, some devices are capable of engaging in more than one mode of communication at the same time.

Resources may be associated with more than one network. For example, a ticket selling service may be available on both the Internet—for Web and WAP access and as an IVR service for users with voice capable telephony devices.

An access device 102 communicates with a particular information network 112 via an associated information network interface 120. For example, in the case of the PSTN, information network interface 120 may be the end office of a LEC (“Local Exchange Carrier”), i.e., an SSP node in the SS7 signaling network. In the case where information network 112 is the Internet and WWW, network interface 120 may be an ISP (“Internet Service Provider”), etc. Information network interface 120 may be any interface between an access network device 102 and an access network 112. For example, according to one embodiment where the access network is the PSTN, information network interface may be a SSP (“Signal Switching Point”) (end office or tandem) of an SS7 network.

Each information network 112(1)-112(N) with which a particular access device 102(1)-102(N) may communicate and initiate operations including session set-up and tear-down functions as an access network with respect to that device. With respect to the present invention, as described above, any resource residing on heterogeneous networks 112(1)-112(N) is accessible via any other information network. The information network providing access with respect to a particular access device thereby function as an access network with respect to the desired resource, and as referred to as an access network herein. Thus, for example, access devices 102(11)-102(1N) interface with information network 112(1) via network interface 120(1), and thereby information network 112(1) function as an access network with respect to these access devices 120(11)-120(1N) with respect to any resources 105 associated with any network 112(1)-112(N). Similarly, information network 112(2) functions as an access net-work for access devices 112(21)-112(2N), etc.

According to the present invention, at least one URP network (405(1)-405(N)), is deployed, each URP network functioning to resolve UTRI requests and initiate a communication session between an access device 102 and a resource 105. URP networks (405(1)-405(N)) may be respectively integrated with each heterogeneous information network 112(1)-112(N) either by utilizing existing infrastructure inherent to access network 405 or by retrofitting additional hardware/software. Note, however, that although FIG. 4 shows one URP network deployed for each possible information network 112, according to alternative embodiments, a single URP network may be deployed, servicing all information networks. For example, according to one embodiment (described in detail below) for the PSTN, a URP network 405(1) is implemented by integrating and retrofitting various nodes in the associated SS7 signaling network. A number of embodiments utilizing the PSTN and the SS7 signaling network are described in detail below.

FIG. 4 shows URP networks 405(1)-405(N) deployed relative to respective information networks 112(1)-112(N). Each URP network 405 includes one or more URP nodes 414, which independently or collectively function to receive and resolve UTRI requests generated by access devices 102 and provide additional finctionality for initiating and establishing sessions as described in detail below. The structure and function of a URP network will become evident as the invention is further described. However, in general, URP networks 405(1)-405(N) collectively or independently function to provide universal access to resources 105 and provide functionality for resolving UTRIs (described in detail below). According to alternative embodiments, URP networks 405 may provide functionality for executing a communications decision process to determine a best communications mode between a resource and an access device, as described in detail below.

For resources residing on networks that do not match the networks that are supported by the access device, either a suitable message informing the user of available access devices or a translation process between networks is employed.

Note that the deployment scheme depicted in FIG. 4 is exemplary and is not intended to limit the scope of the claims appended hereto. For example, according to alternative embodiments, corresponding URP networks 405 may not be deployed for each information network 112 for which resource access is desired. Rather, a single URP network may be deployed externally or internally to a particular information network 112. Or, URP networks 405 may be deployed within certain information networks and not others. Deployment strategies and structures with respect to URP networks 405 will vary depending upon desired performance characteristics for network behavior and functionality.

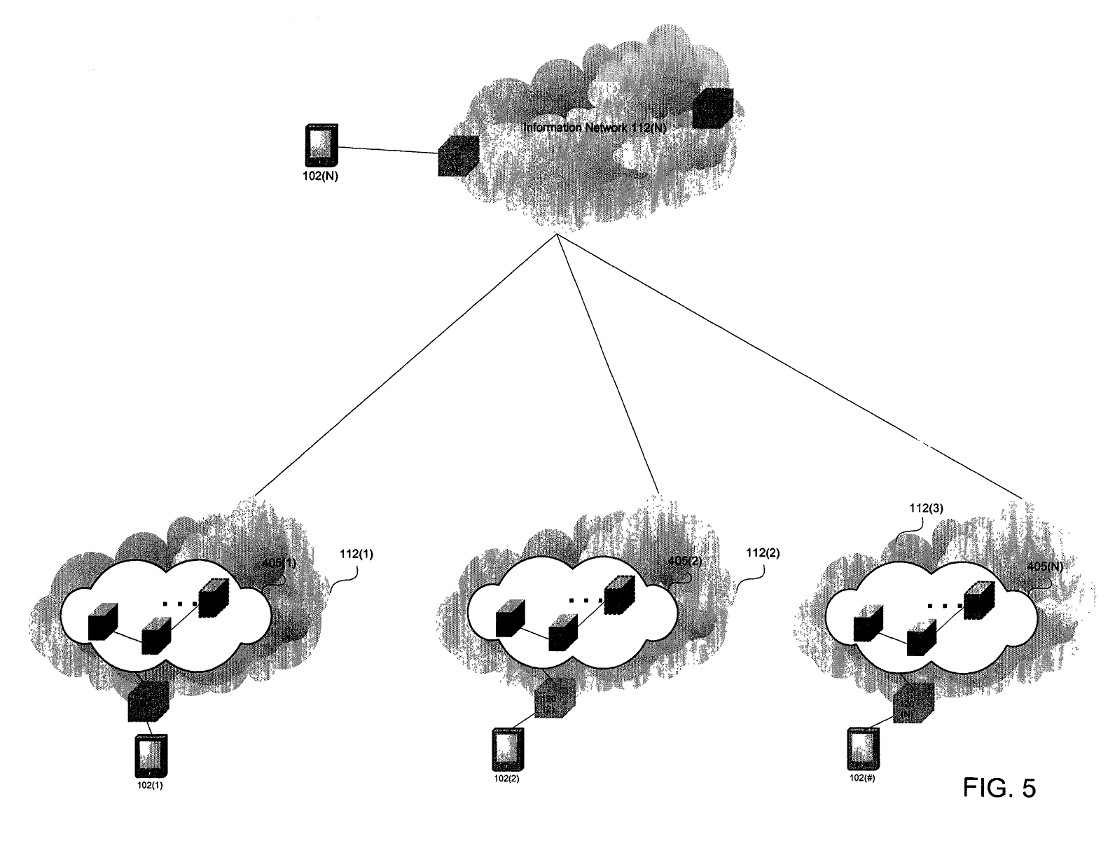

As shown in FIG. 4, URP network 405 includes at least one URP node 414(1)-414(N), the structure of which is described below with reference to FIG. 5. URP nodes 414(1)-414(N) function to receive a UTRI (described in detail below) generated by an access device 102 and received via an access network 112 and network interface 120.

According to the present invention, users may use access devices 102 to access resources associated with the network functioning as the access network as well as resources associated with other (i.e., external) networks. For example, as shown in FIG. 4, according to the present invention, access devices 102(11)-102(1N) may access resources utilizing information network 112(1) as access network. Thereby, access devices 102(11)-102(1N) may access resources 105(11)-105(1N) associated with access network 112(1). However, according to the present invention, access devices 102(11)-102(1N) may also access resources associated with external networks (e.g., 105(21)-105(2N) through resources 105(N1)-105(NN) respectively associated with external information networks 112(2)-112(N)).

According to one embodiment of the present invention, each resource 105 is associated with a UTRI, which is described in detail below. A UTRI provides an immutable scheme for accessing any resource 105 via any information network 112 and associated access device 102. According to one embodiment, each UTRI provides universal access to a resource 102 by functioning as a constant identifier for the resource 105 independent of a particular access network 405. Thus, for example, a WWW page might be associated with a numeric UTRI 1234. According to the present invention, the WWW page would therefore, for example, be accessible via the PSTN 112 (functioning as an access network) by dialing 1234 on a telephony device. Similarly, the WWW page would be available via the Internet and WWW 112 (the Internet and WWW functioning as the access network) by typing the UTRI 1234 into browser software. The WWW page would also be accessible via any other information network 112 whether it be an ISDN network, private network, wireless network, etc. by inputting the UTRI 1234 via a corresponding access network device.

FIG. 5 depicts a scheme for universal access to a resource via any number of access networks according to one embodiment of the present invention. According to the present invention, a particular resource 105 may be accessed via any information network 112(1)-112(N) utilizing any corresponding access device 102(1)-102(N). Thus, as shown in FIG. 5, although resource 105 is associated with information network 112(N) (and therefore using conventional technology only associated via that network), according to the present invention resource 105 may be accessed from any information network 112(1)-112(N) via a respective access device 102.

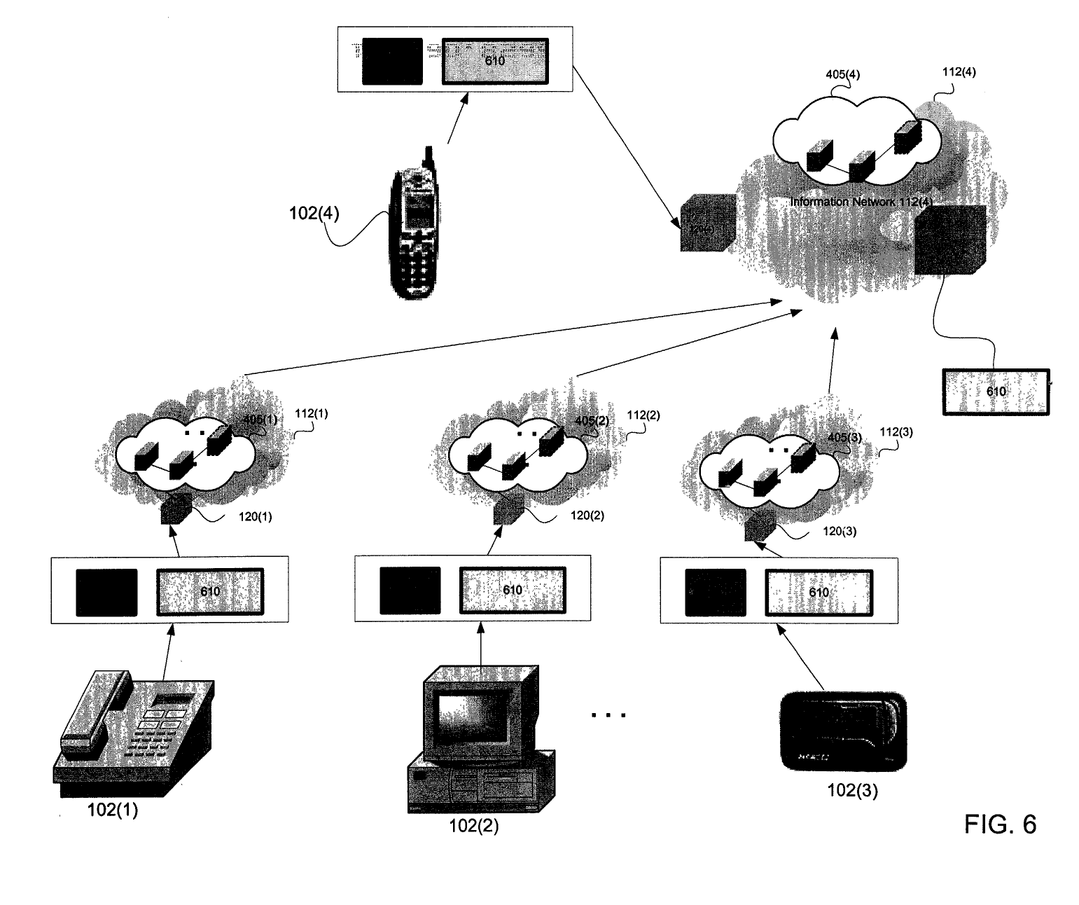

In order to facilitate universal access, URP networks 405(1)-405(N) are deployed respectively for information networks 112(1)-112(N) either utilizing existing infrastructure or retrofitting the respective networks with additional hardware and software. As discussed below with reference to FIG. 6, according to the present invention, universal access to resources 105 may be achieves utilizing a UTRI, which operates independently of the information network 112 functioning as the access network from which access to resource 105 is initiated.

Thus, users of information networks 112(1)-112(N) may indicate their desire to initiate a session with resource 105 by generating UTRI 610 on a corresponding access device 102 utilizing a corresponding access method associated with the access device 102 and information network 112. Note that UTRI 610 is identical for information networks 112(1)-112(N) and thus, a session with resource 105 may be initiated by generating UTRI 610 on any access device 102(1)-102(N) via any information network 112(1)-112(N).

Thus, for example, according to the present invention, if information network 112(N) were the Internet and WWW, resource 105 might be a HTML page residing on a server on the WWW. Thus, users of information network 112(N) (in this example the Internet and WWW) could access resource 105 by generating UTRI 610 using conventional access methods associated with the WWW (i.e., typing the UTRI into browser software).

FIG. 6 depicts the operation of a UTRI according to one embodiment of the present invention. As shown in FIG. 6, UTRI 610 is associated with resource 105 that is respectively associated with information network 112(N). UTRI 610 is an immutable code that may include any number of alpha-numeric characters, and which functions to universally identify resource 105. FIG. 6 depicts four exemplary information networks 112(1)-112(4), each associated with access devices 102(1)-102(4) and network interfaces 120(1)-120(4) respectively. According to the example depicted in FIG. 6, resource 105 is associated with information network 112(4). Also, note that as shown in FIG. 6, URP networks 405(1)-405(4) are respectively deployed with respect to information networks 112(1)-112(4). According to the example depicted in FIG. 6, information network 112(1) may be the PSTN, information network 112(2) may be the Internet and WWW, information network 112(3) may be a pager network and information network 112(4) may be some other network such as a wireless network.

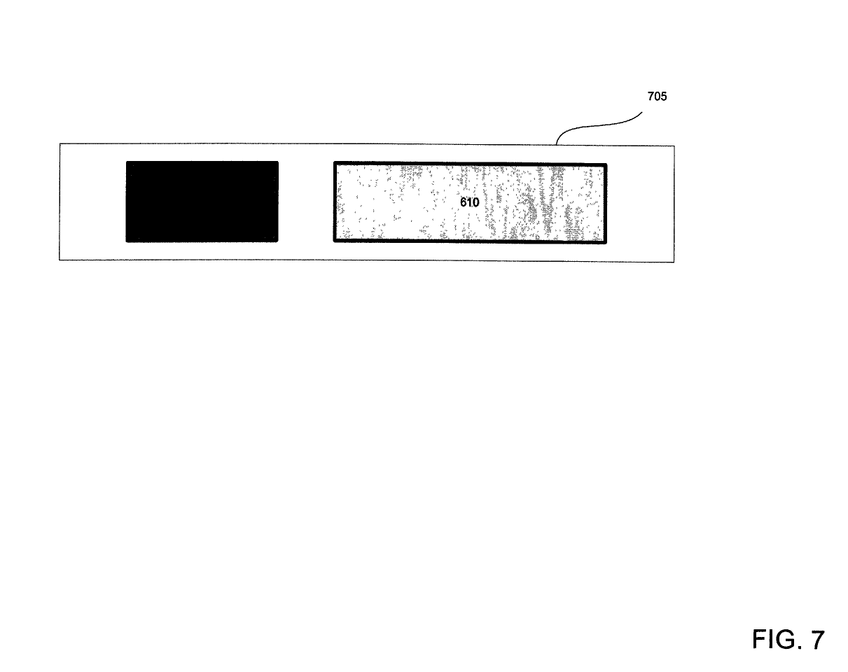

A user of information network 112(1) (PSTN) may initiate a session with resource 105 by dialing corresponding prefix signaling code 710 and UTRI 610 on access device 102(1) (typically a telephone). Prefix signaling code (described in detail below with respect to FIG. 7) is an alphanumeric code utilized for signaling a respective network 112 that a UTRI resolution process is desired. For example, on the PSTN prefix signaling code 710 may be the alphanumeric sequence “*#.” UTRI is received at URP network 405(1) via PSTN 112(1) and network interface 120(1). URP network 405(1) performs fimctions for resolving UTRI 610 (e.g., determining that resource 105 corresponding to dialed UTRI 610 resides on network 112(4)). URP network 405(1) may then perform additional processing to establish a communications session between the user of access device 102(1) and resource 105. An exemplary process for resource resolution and session establishment as performed by a URP network 405 is described in detail below.

A user of information network 112(2) (in this example the Internet and WWW) may initiate a session with resource 105 by typing corresponding UTRI 610 on access device 102(2) (typically a computer terminal equipped with browser software). UTRI is received at URP network 405(2) via Internet and WWW 112(2) and network interface 120(2). Similar to URP network 405(1), URP network 405(2) performs function for resolving UTRI 610 and performing session establishment.

A user of information networks 112(3) (in this example a pager network) nmay initiate a session with resource 105 by dialing corresponding UTRI 610 on pager 102(3) (typically a pager). UTRI is received at URP network 405(3) via pager network 112(3) and network interface 120(3). Similar to URP networks 405(1)-405(2), URP network 405(3) performs functions for resolving UTRI 610 and performing session establishment.

A user of information network 112(4) (in this example a wireless network) may initiate a session with resource 105 by dialing corresponding UTRI 610 on access device 102(4) (typically a wireless device such as a telephone). UTRI is received at URP network 405(4) via wireless network 112(4) and network interface 120(4). Similar to URP networks 405(1)-405(3), URP network 405(4) performs function for resolving UTRI 610 and performing session establishment.

Note that information networks 112(1)-112(4) respectively serve as access networks for access devices 102(1)-102(4) for accessing resource 105. Furthermore, with respect to access devices 102(1)-102(3), resource 105 resides externally to the access network (i.e., on information network 112(4)). However, with respect to access device 102(4), resource 105 resides internally to the access network (i.e., directly on information network 112(4). Also, note that the present invention is compatible and may be implemented utilizing access devices 102 that allow multi-mode capabilities, for example a wireless telephone for communication utilizing a corresponding wireless network as well as being equipped with browser software for communication via Internet and WWW.

FIG. 7 depicts a relationship between a UTRI and a signaling prefix code according to one embodiment of the present invention. As shown in FIG. 7 UTRI package 705 includes signaling prefix code 710 and UTRI 610. Note that the format depicted in FIG. 7 is merely exemplary and not intended in any way to limit the scope of the application or claims appended hereto. Signaling prefix code 710 is a alphanumeric code utilized to signal a particular information network 112 that a UTRI has been provided by a user. For example, in the case where access to resources is provided via the PSTN, signal prefix 710 may be a 2-digit code (e.g., “#*”) to indicate to the signaling system of the PSTN that the user desires to initiate a UTRI resolution process. The specific format for a particular UTRI code 710 will vary depending upon the particular information network 112, architecture chosen for deploying URP network 405, etc.

According to one embodiment, UTRIs may be defined to have a global or local designation. Global UTRIs identify the same resource independent of an information network 112 providing access and/or its geographical location. Local UTRIs depend upon the information network 112 providing access and/or geographical location. Thus, the identical local UTRI submitted from different access networks may be resolved to different resources. In general, the scheme for resolving resources is determined by a network architect as desired. For example, different UTRIs may resolve to a single resource 105. Thus, a resource 105 resolved through a local UTRI may also be resolved through a global UTRI, enabling access to local resource from remote networks. If no such global UTRI exists, the resource can only be accessed locally. UTRIs can be relative to other parameters, such as the user, the access network or a previously resolved resource. The following depict examples of UTRIs and associated signal code:

#*97246380818 can be a global resource.

#*380818, #*972463 or #*44444 may be resolved to locally in several areas.

Dialing #*97246380818 anywhere in the world may resolves to the same local resource as #*380818, #*972463 or #*44444 in exactly one area.

#*11 may be a UTRDI relative to the user, resolving to, for example, the user's home page.

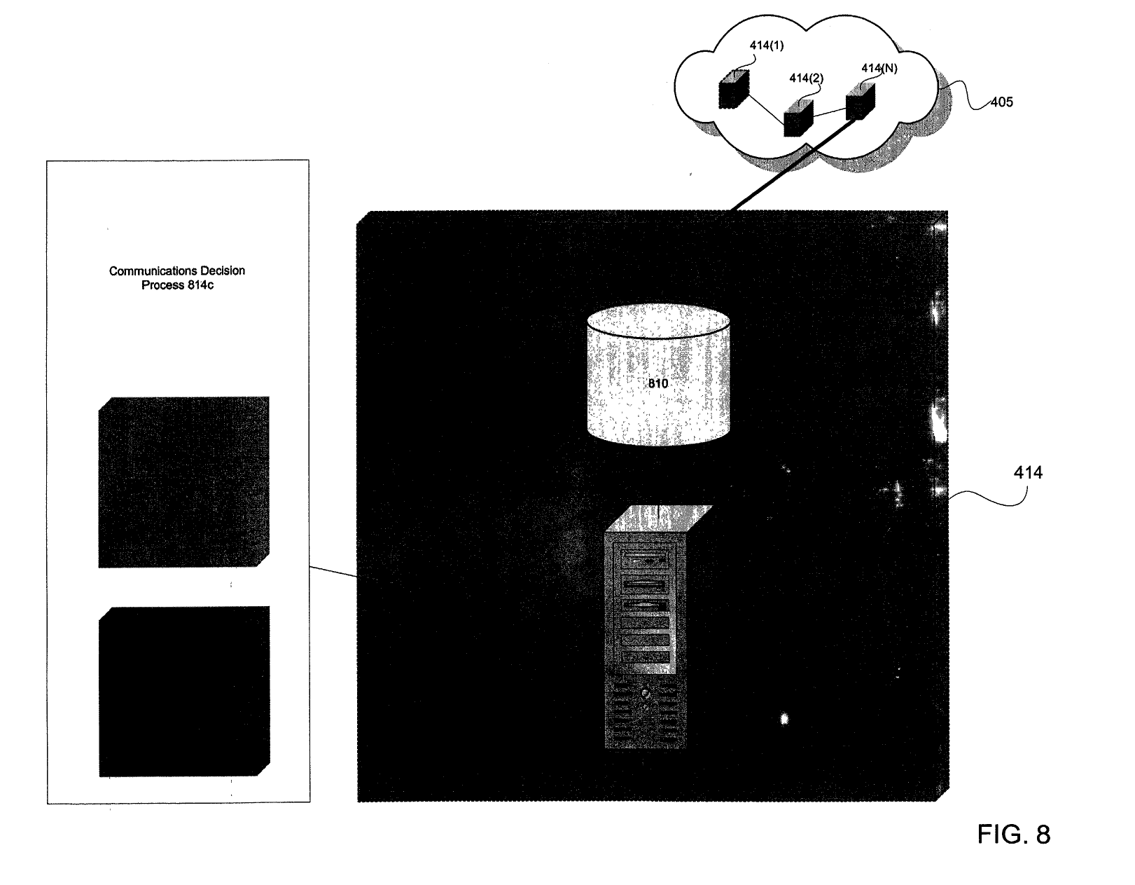

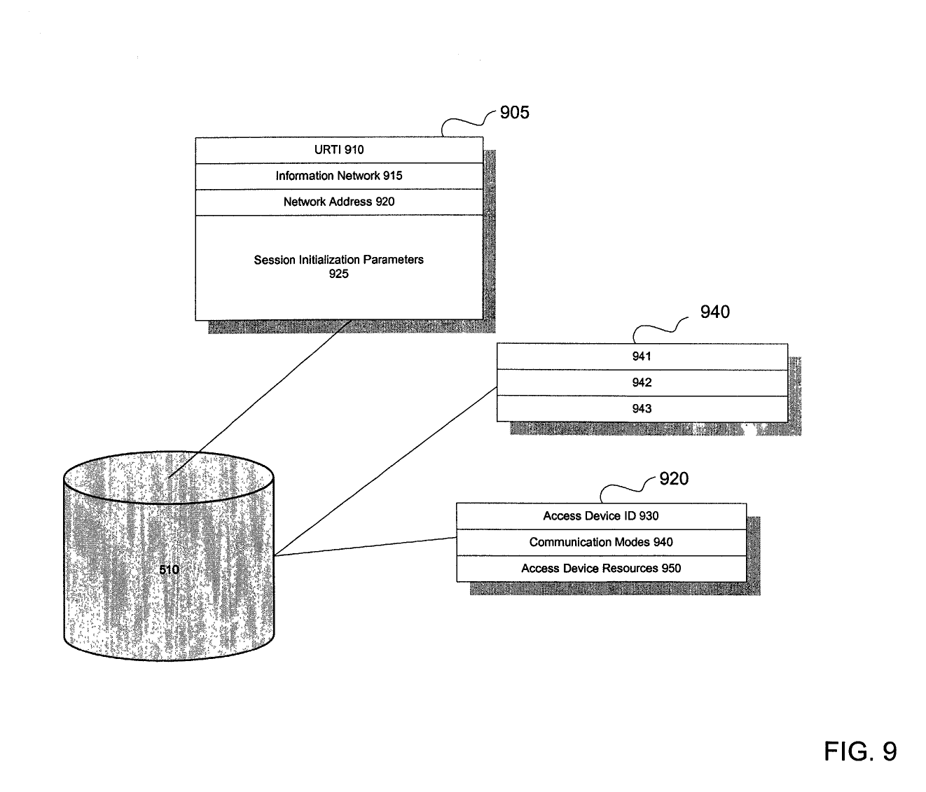

FIG. 8 depicts a structure of a URP node according to one embodiment of the present invention. As shown in FIG. 8, a URP network 405 includes one or more URP nodes 414(1)-414(N), the aggregate of nodes which function to provide resolution of UTRIs generated by users through an access devices 102. As shown in FIG. 8, each URP node 414 includes CPU 820, which is coupled to database 810. Database 810 stores resolution data relating to resolution of UTRIs received at URP node 414 as well as other information, which may be utilized for performing session establishment with particular resources 105 such as communication parameters associated with various access devices 102. A number of exemplary data structures stored in database 820 are depicted in FIG. 9.

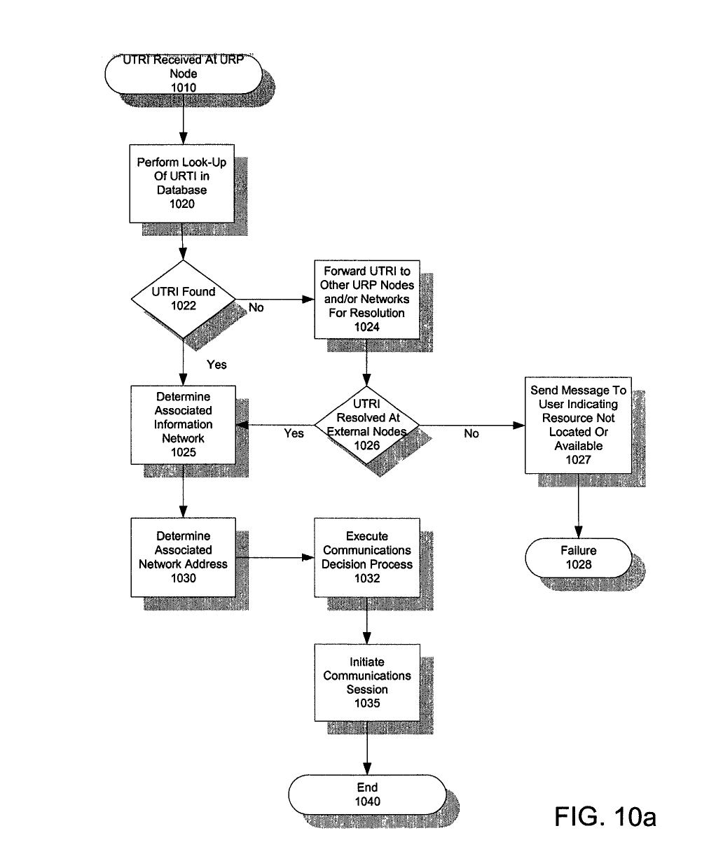

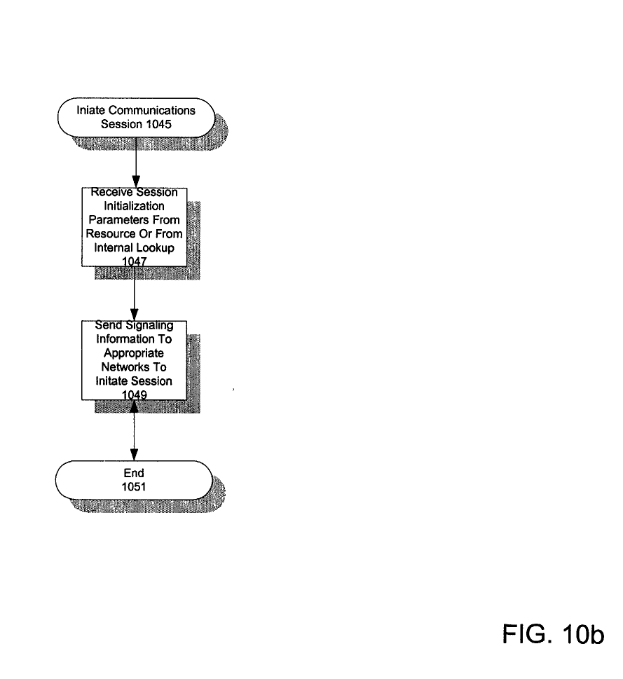

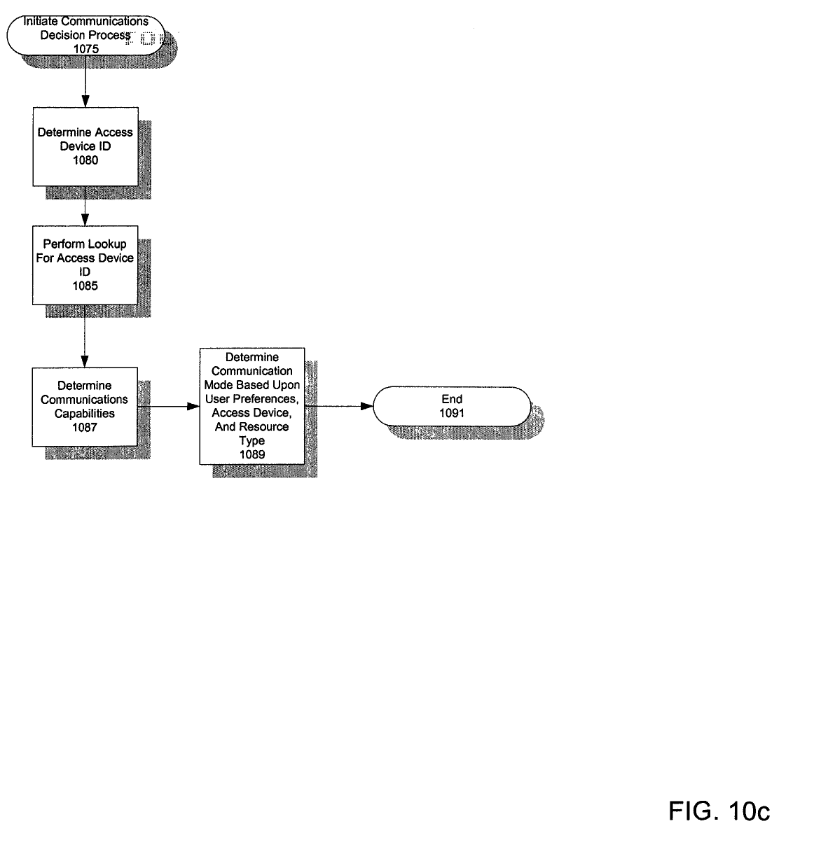

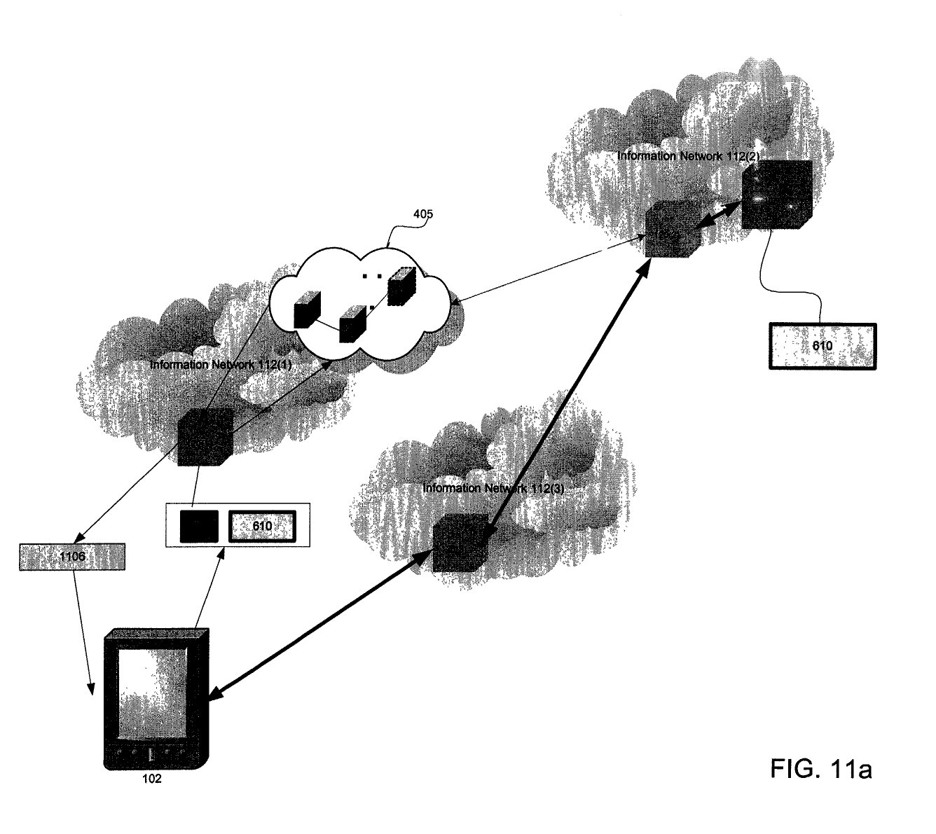

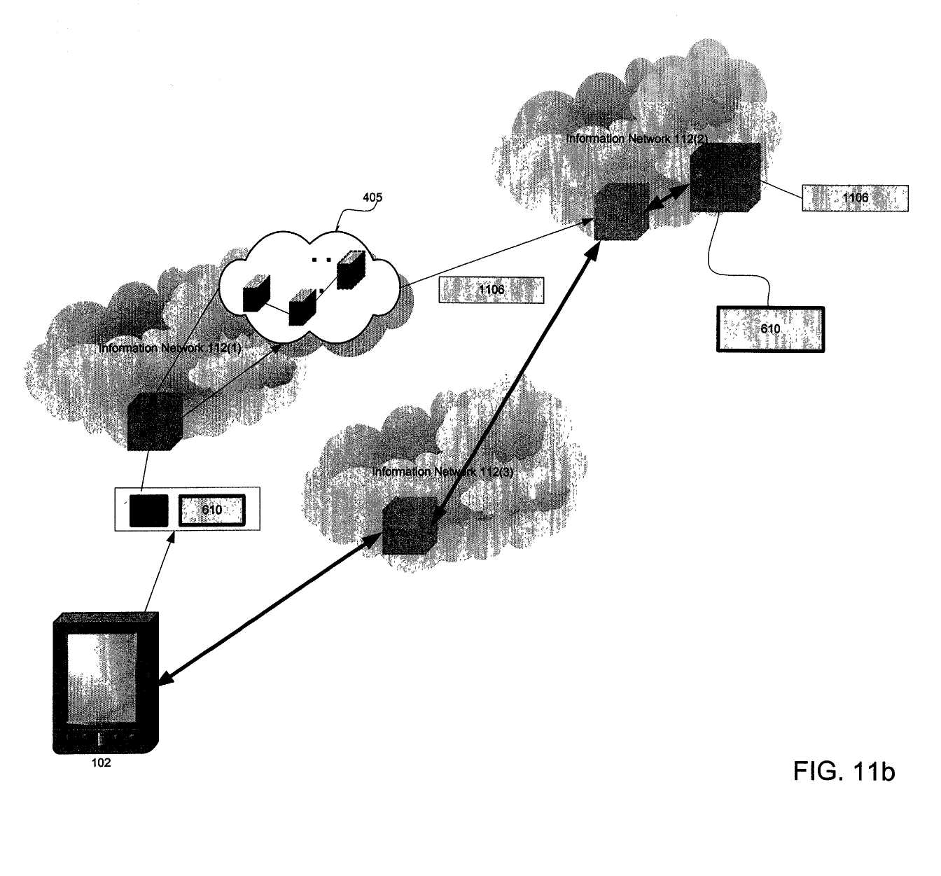

CPU 820 performs processes for UTRI resolution 814a (described in detail with respect to FIG. 10a). According to one embodiment of the present invention, CPU 820 at URP node 414 may also perform session establishment process 814b for initiating a communications session between an access device 102 and a resource 105. According to alternative embodiments, however, session establishment function are performed by resources 105 themselves or by a third-party mechanism as depicted in FIGS. 11b-11c. Also, according to one embodiment, CPU 820 may perform a communication decision process 814c (described in detail with respect to FIG. 10c).

UTRI resolution process 814a determines and identifies a resource 105 associated with a particular UTRI 710 transmitted to URP network 405. According to one embodiment of the present invention, CPU 820 at URP node 414 may also execute a communications decision process 814c. Communications decision process 814c determines a particular communications mode and preferred method for establishing a communications session between a resource 105 and an access device 102. For example, according to one embodiment, communications capabilities information relating to a particular access device 102 is determined relative to a particular access device transmitting a UTRI to URP network 405. Communication capabilities information for an access device may include communications modes available on the access device 102 such as voice, and/or data. Other capabilities information may include display capabilities of the access device 102, bandwidth available at the access device, etc.

In particular, database 810 stores a plurality of UTRI records 905, each corresponding to a particular UTRI. Each UTRI record includes UTRI identifier field 910, information network field 915, network address field 920 and optionally session initialization parameters 925. UTRI identifier field 910 stores an alphanumeric code of a UTRI corresponding to a particular resource 105. Information network field 915 stores an identifier corresponding to an information network 112 where the resource 105 resides. Network address field 920 stores a network address of the resource 105 on the information network 112 on which the resource resides. Session initialization parameters field 925 stores various data relating to initializing a communication session with the corresponding resource. Fields 910, 915 and 920 are utilized by resolution process 814a to perform a UTRI resolution. Field 925 is utilized by session initialization process 814b to initialize a session with the particular resource 105.

According to one embodiment, database 820 at URP nodes 405 may also store a plurality of access device communications capabilities records 940. If a communications decision process 814c is executed by a URP node 414, a plurality of communications capabilities records 940 stored at the URP node 414 (or within the URP network 414) are searched to locate communication capabilities information relative to a particular access device 102 making a UTRI request. Typically, for example, an identifier associated with an access device 102 is transmitted automatically as part of the underlying network protocol. For example, if access device 102 is a telephone, typically the telephone number is transmitted to the PSTN at the initialization of a telephone call. Similarly, if the access device is a computer utilizing a WWW browser on the Internet, typically the IP address associated with the computer terminal may also be determined.

Accordingly, each communication capabilities record 940 stores access device ID field 941, communication mode 942 and access device resources filed 943. Access device ID field 941 stores a unique identifier for an access device. According to one embodiment, for example, if the access device were a telephone, access device ID field 941 would store the telephone number associated with the telephone 102. If, on the other hand, the access device 102 were a computer terminal, access device ID field 941 would typically store an IP address associated with the terminal. Communication modes field 942 stores information indicating available communication modes for a particular access device. For example, if the access device 102 were a WAP enabled wireless telephone with browser software, communication modes field 940 would typically store information indicating that the wireless telephone 102 were capable of operating in a voice mode (digital or analog) and a data mode (WAP) and capable of sending and receiving Short Messages in SMS mode. Device resources field 943 stores additional information relating to available resources on the access device 102 such as bandwidth, display capabilities, etc. Such information could also be obtained from other sources like an external database of the access network itself.

FIG. 10a is a flowchart that depicts a number of exemplary steps for performing a UTRI resolution process according to one embodiment of the present invention. In step 1010, the process is initiated when a UTRI is received at a URP node 414 that may be part of a larger URP network 405. This process may be initiated either when a user generates a UTRI 610 on an access device 102 and transmits the UTRI to an information network 112 or if a UTRI is embedded in a message, which is transmitted to a UTRI message handler (described in detail below). In step 1020, database 810 is consulted to find the received UTRI. In step 1022, it is determined whether the UTRI 610 is found in database 810. If not, (‘no’ branch of step 1022), the received UTRI 610 is forwarded to other UTRI nodes 414 possibly in the same URP network 405 or in an external URP network 405 to attempt resolution. In step 1026, it is determined whether the UTRI 610 was resolved via external URP nodes 414. If not (‘no’ branch of step 1026), an appropriate message is transmitted to the access device 102 that generated the UTRI in step 1027. The process then ends in failure in step 1028.

If the UTRI is resolved (‘yes’ branch of step 1026), flow continues with step 1025. In step 1025, an information network 112 associated with the UTRI is determined via field 915 of the associated UTRI record 905. In step 1030, a network address of the resource 105 associated with the UTRI is determined via network address field 920 in UTRI record 905. In step 1032, optionally, a communications decision process is initiated to determine a best mode of communications between a resource and access device utilizing information stored in access device communications capabilities records 910. A communications decision process is described with reference to FIG. 10c. In step 1035, optionally, a session is initiated with the resource 105 utilizing session initialization parameters field 925. Note that step 1035 is optional. According to one embodiment, a URP node 414 does not participate in session initialization and establishment. However, according to one embodiment URP nodes 414 do participate in session establishment as described in detail below with respect to FIG. 10b. The process ends with success in step 1040.

FIG. 10b is a flowchart of a session establishment process performed by a URP node according to one embodiment of the present invention. The process is initiated in step 1045. In step 1047, initialization parameters are requested and received from the relevant resource. According to an alternative embodiment, however, session establishment parameters are stored locally at the URP node 414 performing resolution and retrieved as a function of the UTRI lookup. Upon determination of the initialization parameters, in step 1049, signaling codes are sent to the appropriate information networks 112 to initiate the session between the access device 102 and resource 105. The process ends in step 1051.

FIG. 10c is a flowchart depicting a series of steps for a communications decisions process performed by a URP node according to one embodiment of the present invention. The process is initiated in step 1075. In step 1080, an identifier of the access device 102 initiating the UTRI request is determined. Typically, the identifier is generated as a function of an address associated with the access device. For example, where the access device is a telephone, the identifier would typically be the phone number associated with the telephone, which is typically transmitted to the network during call setup. On the other hand, if the access device were a computer network connected to the Internet/WWW, the identifier would typically be and IP address assigned to the terminal. In step 1085, communication capabilities records 940 are searched to locate a record matching the identifier of the network device 102. In step 1087, based upon the matching communication capabilities records 940, communication capabilities of the network device 102 are determined. In step 1089, a desired communication mode is determined based upon stored user preferences, the access device and the resources available on the access device.

FIG. 11a is a network diagram a method for performing a user-initiated session initialization process according to one embodiment of the present invention. As shown in FIG. 11a, a user (not shown) dials signal prefix 710 and UTRI 610 on access device 102, which is transmitted to information network 112(1) via network interface 120(1) and forwarded to URP network 405 for resolution. URP network 405 resolves UTRI 610 and determines that the signified resource is associated with information network 112(2). URP network 405 then transmits session establishment information 1106 to access device 102 via information network 112(1) and network interface 120(1). Session establishment information 1106 may be obtained directly from resource 105 via information network 112(2) and network interface 120(2). Or, according to one embodiment, session establishment information 1106 may be stored locally within URP network 405 (e.g., within a database 810 at a URP node 414 and retrieved as a function of a UTRI lookup process.

Access device 102 then utilizes session establishment information 1106 to initiate a communication session with resource 102 via information network 112(3), network interface 120(3), information network 112(2) and network interface 120(2). Note, that according to alternative embodiments, access device may utilize information network 112(1) itself to establish the communications session. FIG. 11a depicts an embodiment in which access device 102 may utilize a multi-mode communications functionality, which allows it to communicate with multiple information networks 112 utilizing a multitude of respective communication protocols.

FIG. 11b is a network diagram a method for performing a resource-initiated session initialization process according to one embodiment of the present invention. As shown in FIG. 11b, a user (not shown) dials signal prefix 710 and UTRI 610 on access device 102, which is transmitted to information network 112(1) via network interface 120(1) and forwarded to URP network 405 for resolution. URP network 405 resolves UTRI 610 and determines that the signified resource is associated with information network 112(2). URP network 405 then transmits session establishment information 1106 to access resource 105 via information network 112(2) and network interface 120(2). According to this embodiment, session establishment information 1106 may be stored locally within URP network 405 (e.g., within a database 510 at a URP node 414 and retrieved as a function of a UTRI lookup process. According to an alterative embodiment, however, session establishment information 1106 is stored by resource 105

Resource 105 then utilizes session establishment information 1106 to initiate a communication session with access device 102 via information network 112(3), network interface 120(3), information network 112(2) and network interface 120(2). Resource 105 may have received session establishment information 1106 from URP network 405 or may utilize session establishment information 1106 stored by resource 105 itself. Note, that according to alternative embodiments, resource 105 may utilize information network 112(1) itself to establish the communications session. FIG. 11b depicts an embodiment in which access device 102 may utilize a multi-mode communications functionality, which allows it to communicate with multiple information networks 112 utilizing a multitude of respective communication protocols.

FIG. 11c is a network diagram a method for performing a third-party-initiated session initialization process according to one embodiment of the present invention. As shown in FIG. 11c, a user (not shown) dials signal prefix 710 and UTRI 610 on access device 102, which is transmitted to information network 112(1) via network interface 120(1) and forwarded to URP network 405 for resolution. URP network 405 resolves UTRI 610 and determines that the signified resource is associated with information network 112(2). URP network 405 then transmits session establishment information 1106 to access device 102 via information network 112(1) and network interface 120(1). Session establishment information 1106 may be obtained directly from resource 105 via information network 112(2) and network interface 120(2). Or, according to one embodiment, session establishment information 1106 may be stored locally within URP network 405 (e.g., within a database 810 at a URP node 414 and retrieved as a function of a UTRI lookup process.

Access device 102 then transmits session establishment information 1106 to third-party 1125 and requests that third-party 1125 initiate a communication session with resource 102. Third-party 1125 then initiates a communication session between resource 105 and access device 102 via information network 112(3), network interface 120(3), information network 112(2) and network interface 120(2). Note, that according to alternative embodiments, third-party 1125 may utilize information network 112(1) itself to establish the communications session. FIG. 11c depicts an embodiment in which access device 102 may utilize a multi-mode communications functionality, which allows it to communicate with multiple information networks 112 utilizing a multitude of respective communication protocols.

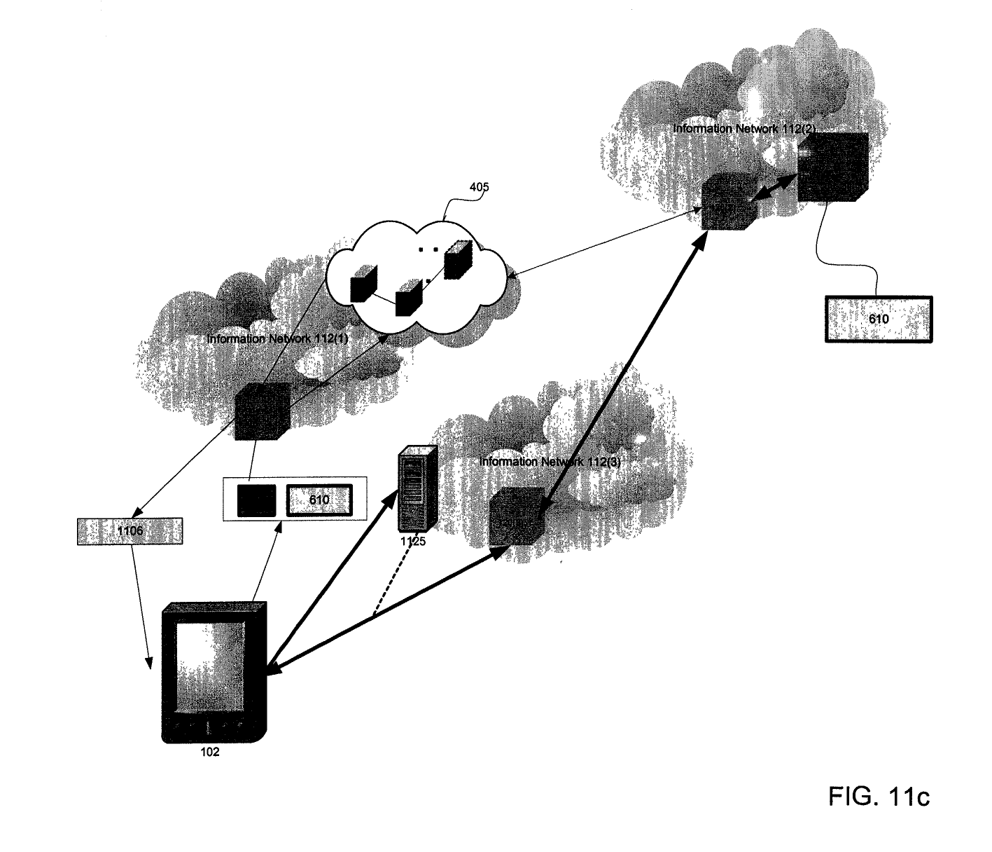

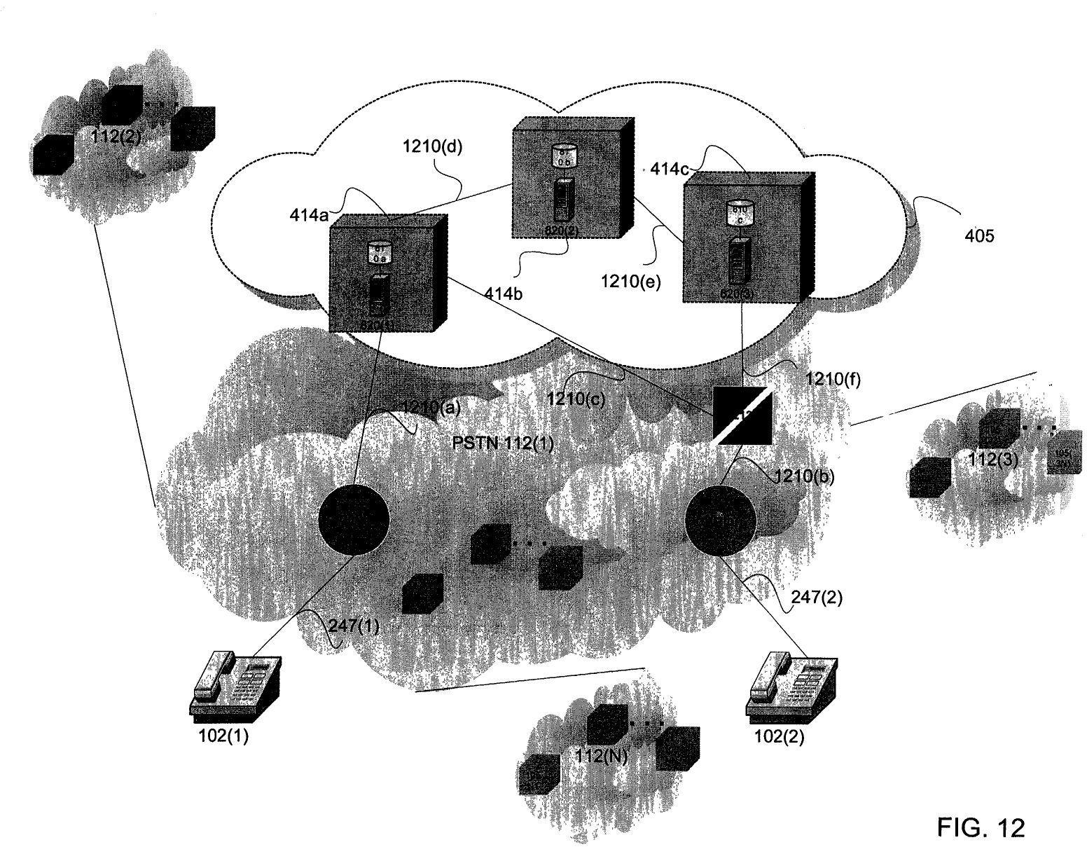

FIG. 12 is a block diagram illustrating the integration of a URP network into the PSTN in order to provide universal resource access according to one embodiment of the present invention. PSTN 112(1) is coupled to one or more other information networks 112(2)-112(N), which may be for example the Internet and WWW, a wireless network, a pager network, etc. Information networks 112(2)-112(N) are each associated with one or more resources 105(21)-105(2N)-105(N1)-105(NN). In addition, PSTN 112(1) is itself associated with a set of resources 105(11)-105(1N), which may include PSTN voice telephony endpoints (i.e., voice telephony endpoints). Other resources associated with PSTN 112(1) may include IVR systems, FAX endpoints, etc. FIG. 12 also shows telephony devices 102(1)-102(2) respectively coupled to SSP nodes 201a-201(b) on PSTN via respective subscriber lines 1230(1)-1230(2). In this case, subscriber lines 247(1)-247(2) may also be viewed as resources 105 associated with PSTN 112(1) in that they provide a fixed bandwidth for conducting voice and other communications over PSTN 112(1).

As shown in FIG. 12, URP network 405 including URP nodes 414(a)-414(c) (each including respective processor 520(1)-520(3) and database 810(1)-810(3)) is deployed to PSTN 112. According to one embodiment of the present invention each URP node (e.g., nodes 414(a)-414(c)) in URP network 405 is implemented as an SS7 STP 212 node. According to the example shown in FIG. 12, URP network 405 is coupled to PSTN 112 via pre-existing STP node 212 via link 1210(f) (coupling STP node and URP node 414(c)), via access link 1210(a) coupling SSP node 201a and URP node 414a and via access link 1210(c) coupling STP node 212 to URP node 414a.

URP nodes 414a-414c are coupled together via links 1210(d) and 1210(e). Note that only three URP nodes 414a-414c are shown in the exemplary embodiment of FIG. 3. In general, the number and configuration of URP nodes 414 within a deployed URP network 405 will vary depending upon choices made by the network architect. In general, the architecture depicted in FIG. 12 is merely exemplary and is not intended to limit the scope of the claims appended hereto.

Each URP node 414a-414c in URP network 405 includes respective processor 820(1)-820(3) as well as respective database 810(1)-810(c). According to one embodiment, each URP node 414 receives UTRI resolution request messages (formulated as SS7 IAM messages) and attempts to resolve the UTRI 610 to determine a corresponding resource.

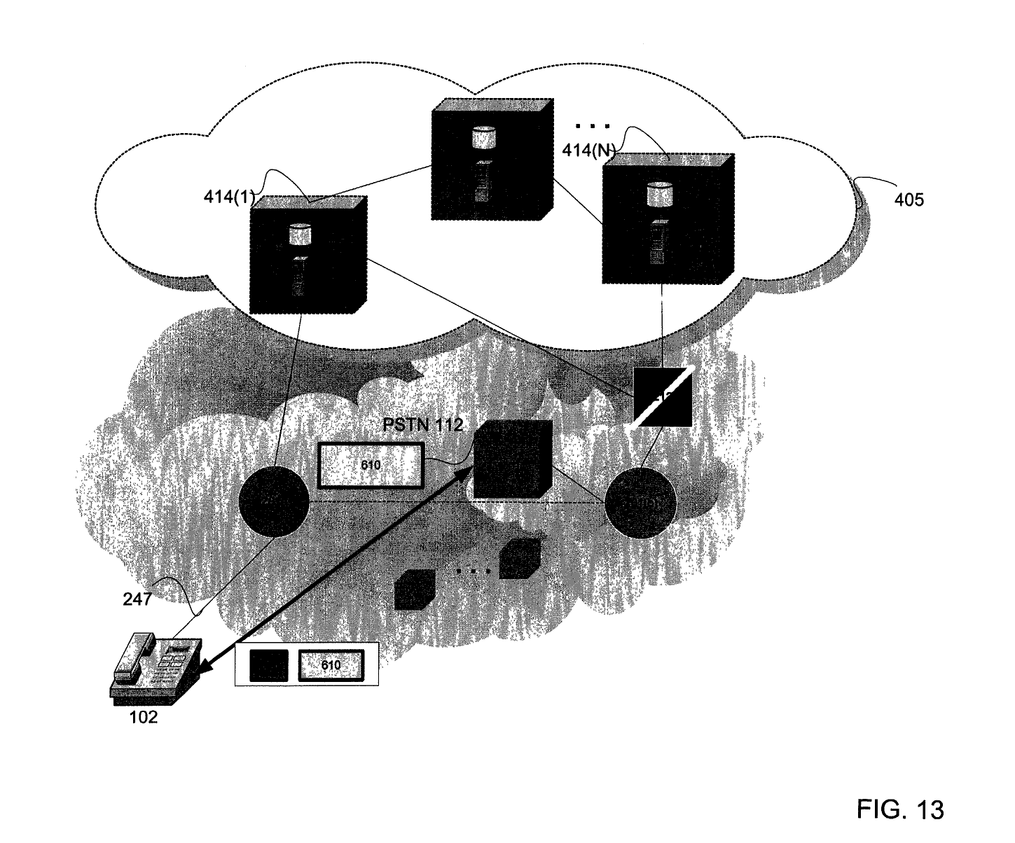

FIG. 13 depicts an exemplary network configuration for establishing a PSTN communication channel with a resource associated with the PSTN according to one embodiment of the present invention. As shown in FIG. 13, PSTN 112 is associated with any number of resources 105(1)-105(N). Resources may be, for example, voice endpoints connected to a LEC or SSP, FAX endpoints connected to a LEC or SSP or an IVR system, among other things. For the example shown in FIG. 13, it is assumed that resource 105(1) is an IVR system, in particular an IVR server. Furthermore, it is assumed that a user (not shown) utilizes access device 102 (in this case a telephone) to connect to PSTN 112.

The user utilizes telephone access device 102 to dial a UTRI 610 and signal prefix 705, which is transmitted to SSP 201a, which in this case functions as a network interface 120. SSP 201a accepts the request and generates an IAM, which it then sends to URP network 405 (including URP nodes 414(1)-414(N)) via link 1210(a). URP network 405 resolves UTRI 610 to determine that it is associated with resource 105(1), an IVR system and server. Communication decision process 614c is then invoked to determine that a voice session should be established with IVR server IC5(1). After resolving the resource request, URP network determines that the desired resource is IVR server 105(1) and sends an IAM message back to PSTN 112 including the telephone number of the IVR server 105(1). PSTN 112 sends the IAM to SSP 201(b) and if IVR server 105(1) can accept the call, sends an ACM response back to SSP 611 via PSTN 612. If the response was a positive response, a virtual circuit is established between telephone access device 102 and IVR server 105(1).

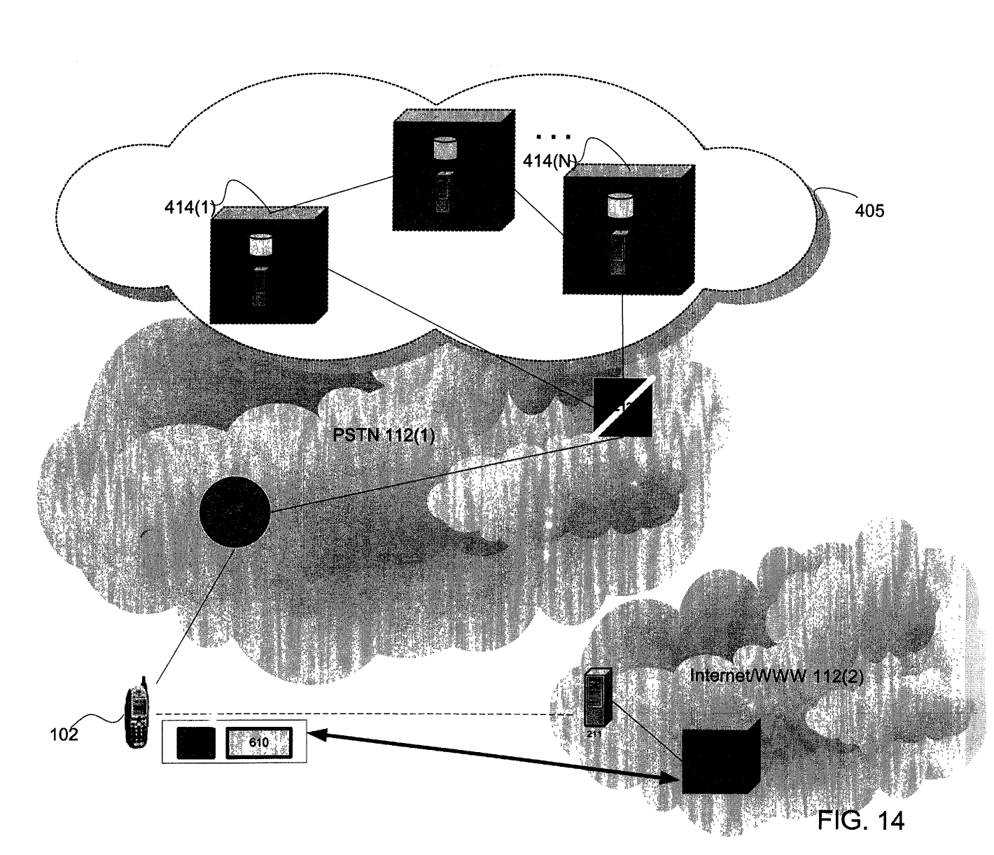

FIG. 14 depicts an exemplary scenario scenario for establishing a WAP communication session according to one embodiment of the present invention. It is assumed, for the purpose of this example, that a user desires to access resource 105 (associated with WAP server 211) that resides on Internet/WWW 112(2). For example, resource 105 may be a WWW page.

As shown in FIG. 14, a user utilizes access device 102, in this case a cellular telephone that is equipped with browser software, to dial a UTRI associated with resource 105 associated with Internet/WWW 112(2). SSP 201 accepts the request and generates an IAM, which is transmitted to URP network 405. The UTRI is resolved at a particular URP node (e.g., 414(1)) and a communications decision process 814(c) is executed. The decision process 814(c) determines that access device 102 has prerequisite WAP capabilities and determines that it should communicate with resource 105 over a WAP session. A URP node (e.g., 414(1)) generates an RLC message and transmits the message back to PSTN 112. PSTN transits the RLC message back to SSP 201, which refuses the call attempt from access device 102, possibly playing an appropriate explanatory message.

The resolving URP node (e.g., 414(1)) executes a session initiation process 814(b), which causes a session to be established between access device 102 and WAP server 211, which is the server for resource 105 (identified by the appropriate URL). A WAP session is thus established between wireless access device 102 and WAP server 211.

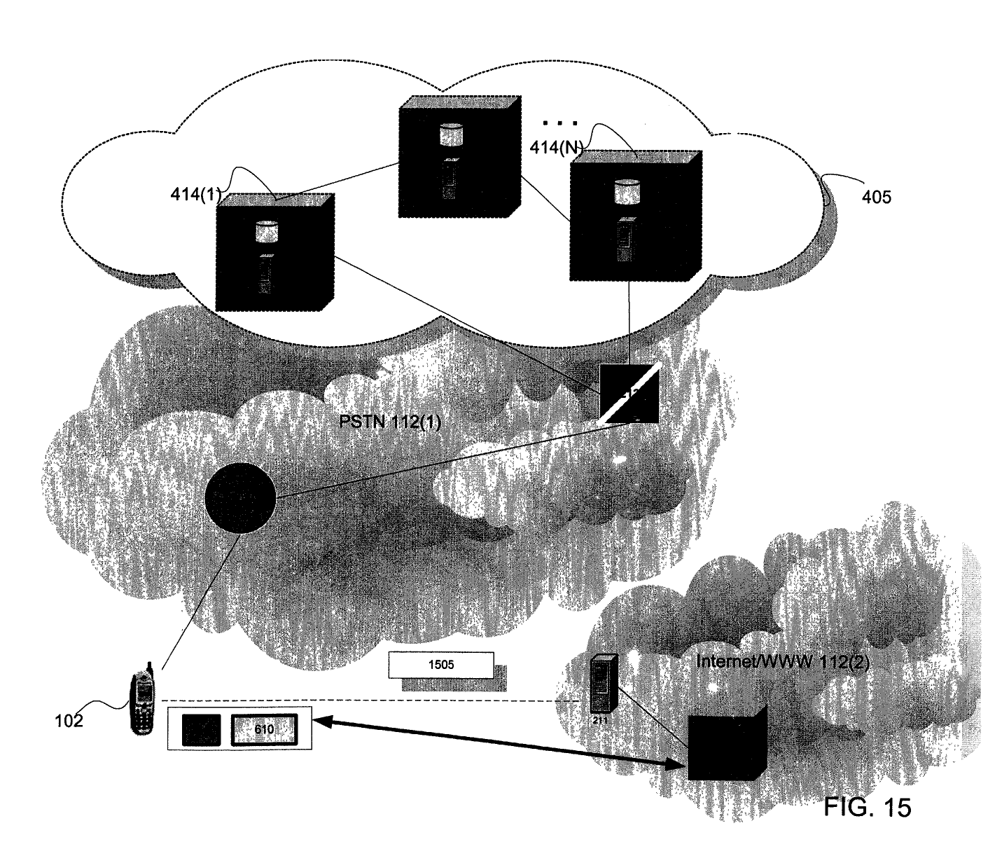

FIG. 15 depicts an exemplary scenario for establishing an e-mail communication according to one embodiment of the present invention. It is assumed, for the purpose of this example, that a user desires to receive an e-mail communication from resource 105, that is associated with Internet/WWW 112(2). Resource 105 may be, for example, an HTML page or collection of HTML pages comprising a website.

As shown in FIG. 15, a user utilizes access device 102, in this case a cellular telephone that is WAP enabled, to dial a UTRI associated with resource 105. SSP 201 accepts the request and generates an IAM, which is transmitted to URP network 405. The UTRI is resolved at a particular URP node (e.g., 414(1)) and a communications decision process 814(c) (see FIG. 8) is executed.

Communications decision process 814(c) determines that access device 102 is Internet enabled with email capabilities (either using an internal lookup table or by contacting a centralized server or by receiving the information by communicating with the device) (i.e., access device 102 has the prerequisite e-mail capabilities). A URP node (e.g., 414(1)) generates a REL message and transmits the message back to PSTN 112. PSTN transits the RLC message back to SSP 201, which refuses the call attempt from access device 102, possibly playing an appropriate explanatory message.

The resolving URP node (e.g., 414(1)) executes a session initiation process 814(b) (see FIG. 8), which causes an e-mail sending mechanism associated with resource 105 to send an e-mail message to access device 105. For example, as depicted in FIG. 15, e-mail server 211, which is associated with resource 105, transmits an e-mail message to wireless access device 105. The user that is operating wireless access device 102, upon receipt of the e-mail message, may respond as desired, thereby effecting a two-way e-mail communication session.

Alternatively, if the user has specified an email address, than even if the device was not email capable, the connection request could still be completed by sending the email to the designated address, which could be stored as part of the URP node's database. In this case, the email address directing email to some email server can be considered to be an extension of the communication capabilities of the device, as the communication was effected by the device with predictable and controlled results.

According to one embodiment, a LEC (“Local Exchange Carrier”) switch associated with the PSTN receives a dialed access code 705 and UTRI 610. Upon receipt of the access code, the LEC establishes an appropriate switching operation to establish communications between the telephony user and the UTRI 610 such as connecting the telephony user with a URP node implemented as a signaling entity on the network. The dialed UTRI 610 is transmitted to the URP node, which receives the resource identifier and performs appropriate processing to resolve the UTRI 610 to a resource and establish access thereto.

According to one embodiment, a telephony user desiring to access a resource sends a USSD (“Unstructured Supplementary Services Data”) message comprising a URP service code and a UTRI 610 using a telephony or other USSD capable device. The USSD service code and UTRI are processed and appropriate switching and signaling operations performed to provide access to the telephony user of the desired resource. According to one embodiment, a USSD server associated with a PLMN (“Public Land Mobile Network”) receives a sent service code and UTRI. Upon receipt of the USSD request, the USSD server establishes a session with the URP node identified by the service code and transmits the UTRI and connection information to the URP node. The URP node receives the UTRI and connection information and performs appropriate processing to resolve the UTRI to a resource and establish access thereto.

According to one embodiment, a telephony user desiring to access a resource sends an SMS message possibly containing information to a destination comprising an access code and UTRI using a telephone or other SMS capable device. The UTRDI and related information are processed and appropriate switching and signaling operations performed to provide access to the telephony user of the desired resource. According to one embodiment, an SMSC (“Short Message Service Controller”) associated with a PLMN receives a sent SMS message sent to a UTRI 610 comprising an access code and UTRI 610. Upon receipt of the SMS message, the SMSC establishes a session with the URP node identified by the access code and transmits the UTRI and SMS message to the URP node. The URP node receives the UTRI 610 and SMS message and performs appropriate processing to resolve the UTRI to a resource and establish access thereto. According to one embodiment, a telephony user desiring to access a resource sends an SMS message comprising a UTRI and possibly containing information to a URP node destination using a telephony or other SMS capable device. The UTRI and related information are processed and appropriate switching and signaling operations performed to provide access to the telephony user of the desired resource.

According to one embodiment, an SMSC associated with a PLMN receives an SMS message sent to a URP node 414. Upon receipt of the SMS message, the SMSC establishes a session with the URP node 414 identified by the access code and transmits the SMS message to the URP node 414. The URP node 414 receives the SMS message comprising a UTRI 610 and related information and performs appropriate processing to resolve the UTRI 610 to a resource and establish access thereto.

According to one embodiment, a pager user desiring to access a resource sends a pager message possibly containing information to a destination comprising an access code and UTRI 610 using a pager or other paging capable device. The UTRI 610 and related information are processed and appropriate switching and signaling operations performed to provide access to the pager user of the desired resource.

According to one embodiment, an PNC (Pager Network Controller) associated with a pager network receives a pager message sent to a UTRI 610 comprising an access code and UTRI610. Upon receipt of the pager message, the PNC establishes a session with the URP node identified by the access code and transmits the UTRI and message to the URP node. The URP node 414 receives the UTRI 610 and message and performs appropriate processing to resolve the UTRI 610 to a resource 105 and establish access thereto.

According to one embodiment, a pager user desiring to access a resource sends a pager message comprising a UTRI 610 and possibly containing information to a URP node destination. The UTRI 610 and related information are processed and appropriate switching and signaling operations performed to provide access to the pager user of the desired resource.

According to one embodiment, a PNC associated with a pager network receives a pager message sent to a URP node. Upon receipt of the pager message, the PNC establishes a session with the URP node transmits the pager message to the URP node. The URP node 414 receives the pager message comprising a UTRI 610 and related information and performs appropriate processing to resolve the UTRI 610 to a resource 105 and establish access thereto.

According to one embodiment, an email user desiring to access a resource sends an email message possibly containing information to a destination comprising an URP node address and UTRI through an email server (e.g., UTRI@URP₁₃ NODE_ADDRESS or UTRI: URP_NODE@MAIL_SERVER_ADDRESS). The UTRI 610 and related information are processed and appropriate switching and signaling operations performed to provide access to the email user of the desired resource.

According to one embodiment, an mail server associated with a communication network receives an email message sent to a UTRI 610. Upon receipt of the message, the email server establishes a connection with a URP node identified by the host address and transmits the UTRI 610 and message to the URP node 414. Alternatively the mail server itself is a URP node 414. The URP node 414 receives the UTRI 610 and message and performs appropriate processing to resolve the UTRI 610 to a resource and establish access thereto.

According to one embodiment, an e-mail user desiring to access a resource sends an email message possibly containing UTRI 610 and information to a URP node 414 via an email server (e.g., URP_NODE@MAIL_SERVER_ADDRESS. The UTRI and related information are processed and appropriate switching and signaling operations performed to provide access to the email user of the desired resource.

According to one embodiment, a mail server associated with a communication network receives an email message sent to a URP_NODE. Upon receipt of the message, the email server establishes a connection with a URP node 414 identified as the recipient of the message transmits the UTRI 610 and message to the URP node 414. The URP node 414 receives the UTRI 610 and message and performs appropriate processing to resolve the UTRI 610 to a resource and establish access thereto.

According to one embodiment, an Internet user desiring to access a resource provides a URI such as a URL encoding the UTRI through an HTTP capable user agent.either directly or by clicking a link or some other mechanism that directs the user agent to GET or POST the URL (e.g., http://URP_NODE_ADDRESS/UTRI or utri://UTRI assuming the UTRI scheme is known by the user agent, which will generate an HTTP or other appropriate connection with a URP node). The UTRI 610 and related information possibly transmitted as query parameters are processed and appropriate switching and signaling operations performed to provide access to the Internet user of the desired resource.

According to one embodiment, an HTTP server associated with a communication network and acting as a URP node 414 or connected to a URP node 414 receives a GET request. Upon receipt of the request, the URP node 414 performs appropriate processing to resolve the UTRI 610 to a resource and establish access thereto.

According to one embodiment, a telephony user desiring to access a resource connects to an IVR server and provides the UTRI 610 via DTMF tones. The UTRI 610 and related information are processed and appropriate switching and signaling operations performed to provide access to the Internet user of the desired resource.

According to one embodiment, an IVR server associated with a telephony network and acting as a URP node 414 or connected to a URP node 414 accepts a user call and prompts the user to enter the UTRI 610 and other related information. Upon receipt of the information, the URP node 414 performs appropriate processing to resolve the UTRI to a resource and establish access thereto.

According to one embodiment of the invention, the URP node 414 may engage in a data retrieval action with the user, retrieving data which is essential for the resource to be accessed correctly. Such dialogs are carried on the communication network used by the user to access the resource, or on another communication network accessible by both the user's device and the URP node 414. For example, a URP node 414 contacted over the Internet may present a Web form to be completed; a URP node 414 on a telephony network may engage in an IVR session with the user. A URP node 414 contacted by USSD will continue the USSD session by sending information retrieval screens. An SMS or pager URP node 414 can send the user a message instructing him to reply with appropriate information. A URP node 414 on an SS7 network may switch the call to an IVR, WAP or some other session, retrieve the information and continue the normal signaling and switching operation.

According to one embodiment a universal class of resources herein referred to as Universal Shell Objects (“USOs”) are defined. USOs function as a template mechanism to provide generic access to arbitrary services.

Similar to any other resource, USOs are identified by UTRIs 610. USOs serve as anchor points for arbitrary services, these services are said to be associated with the USO. These services may effect the delivery of goods of information. Users connect to USOs to interact with these services in what is called a transaction. Once a UTRI 610 is resolved to a USO, the USO is provided with data pertaining to the user that is contacting it, such as user classification, preferences, capabilities, permissions, security and authentication data, personal and demographic data and profiling information; device information, such as which access network was used to enter the UTRI, device capabilities and limitations, bearer capabilities and routing information; contextual information, such as device or user location, locale information such as language, temporal information such as the time or any other external information, such as market index values or the fact that some event had occurred or not. The collection of information is called the environment of the transaction.

Based on this information, USOs determine an action to be performed with respect to the user contacting the USO. In order to do so, USOs confer with all services which are anchored to them. These services may be anchored on a specific USO level or at a higher USO class level. More than one USOs may be involved in a transaction. In that case, the services associated with all these USOs may be consulted.

The transaction is sent to all the services associated with the USO along with the transaction environment. Each service is afforded an opportunity to influence the final outcome of the request. The responses from these services can cause other services to be consulted, some action to be performed, some information to be presented to the user, via audio, visual or tactile means, screens to constructed or lists of options to be presented to the user. For example, a user connecting to some UTRI 60 may be sent an email message with some information in it; be presented with a menu of available options or have some specific action performed.

When USOs are associated with articles of press or commerce which they create a level of interactivity hitherto not available for displayed objects. Associating a USO of class “Classified” with a printed classified ad creates an Interactive Classified Ad which can be accessed from any access network by inputting the USO's UTRI. The same holds for editorial material, advertisements, any broadcasted material, articles of commerce, business documents, entertainment material, material objects such as medicine, clothing, electronics, food, cars or other goods. Even people, users, may have USOs associated with them.

The USO defines the interfaces and metadata that is required of services so that they can be presented to the user if needed, consulted on transactions and invoked if selected by the user. Management interfaces exist to create, destroy and otherwise manage the lifecycle of USOs, associate services with USOs, configure the services associated with USOs, define presentation formats for different access channels and capabilities, define USO classes and objects and any special USO behavior as well as manage access permissions and association of UTRIs 610 with USOs.

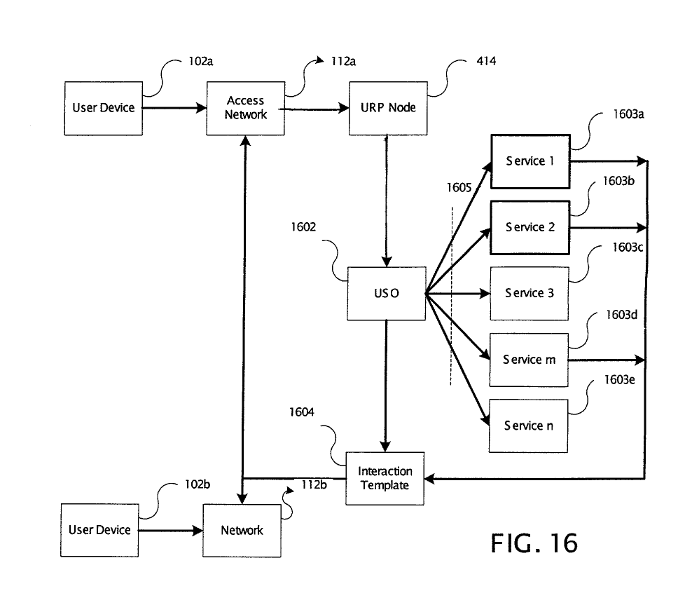

As shown in FIG. 16, a user uses an access device 102a to contact a USO 1601 identified by a UTRI. The request is sent to the access network 112a and forwarded to the URP Node 414 which could be a part of a URP network. The URP Node resolves the UTRI to USO 1601 and sends an OPEN request to the USO 1601. This request contains any of this information: The user identity, user parameters, user preferences, device capabilities, network capabilities, external parameter such as time, locale, location information etc.

The USO sends this request to those associated services 1603a. . . 1603n which did not fail the precondition test 1605. This precondition test is a set of predicates that pertain to the request, such as the request type, the capabilities of the access channel, time of day, etc. The set of predicates is provided by the associated services upon association.

Each service processes the request and determines what responses, if any, it wants to generate. These responses may include invocations of other services, output directives, command directives to the USO, etc.

The USO also generates the appropriate interaction template 1604 which is used as a map that determines how to interpret the responses from the various services. The template has execution capabilities, to execute command responses and has static layout capabilities to generate output based on output responses. For output purposes the templates may be a simple variable based substitution mechanism, where each response element declares the role that it plays in the reply. The set of all roles is aggregated and sent to the interaction template which substitutes the appropriate roles in the output template to generate a complete response. Which could, for example, be a WML page, or a command to play a wav file followed by an SMS message to be sent.

This complete response is sent back for delivery to the access network 112a for display on device 102a. This network may be augmented by or replaced by another network 112b connected to some other device 102a.

A method and system for universal and transparent access to resources residing on heterogeneous networks has been described. A universal transparent identifier is associated with desired resources residing on the heterogeneous networks. A resource resolving network is deployed relative to one or more information networks. The resolving network function to resolve universal resource identifiers and initiate a communications session with the desired resource.

What is claimed is:

1. A method for providing access to resources on heterogeneous networks via any network and associated access network device, comprising the steps of:
a. associating each of a plurality of resources with a respective universal resource identifier;
b. receiving a resource identifier associated with a desired resource via an access network;
c. resolving the resource identifier to determine information associated with the desired resource, wherein the desired resource may reside on any of the heterogeneous networks;
d. causing a communications session to be established with the desired resource.

2. The method according to claim 1, further including the steps of:
a. determining at least one communications capability of an access device; and,
b. selecting from the at least one communications capability, a preferred communications capability.

3. The method according to claim 2, wherein the communications session is established as a function of the preferred communications capability.

4. The method according to claim 1, wherein step (b) further includes the steps of receiving a signal prefix for signaling the access network that a UTRI has been transmitted.

5. The method according to claim 1, wherein the access network is the PSTN.

6. The method according to claim 5, wherein the UTRI is generated by a dialing operation on a telephony device.

7. The method according to claim 1, wherein the UTRI is embedded in a message.

8. The method according to claim 7, further including the step of extracting the UTRI from the message.

9. The method according to claim 7, wherein the message is one of an e-mail message, an SMS message, an instant message and a pager message.

10. The method according to claim 2, wherein the step of determining a communications capability of the access device further includes the steps of:
a. storing a table, which associates an access device identifier with at least one communications capability;
b. receiving an access device identifier associated with the access device; and,
c. searching the table for the access device identifier to find at least one communications capability for the access device.

11. The method according to claim 10, wherein the step of selecting a preferred communications capability further includes the step of consulting a pre-defined preference table, wherein the pre-defined preference table associates a desirability ranking for communications capabilities with respect to one another.

12. The method according to claim 1, wherein the heterogeneous networks include the PSTN, the Internet, a pager network and a wireless network with or without data capabilities including SMS, EMS, MMS and USSD.

13. A method for providing access to resources on heterogeneous networks from any network comprising the steps of:
a. associating each of a plurality of resources with a respective universal resource identifier;
b. deploying a resource resolution network, accessible via any information network, wherein the resource resolution network includes at least one resource resolution node adapted to:
1) receive a selected resource identifier corresponding to a desired resource;
2) resolve the selected resource identifier to determine information associated with the desired resource; and,
3) establish a communications session with the desired resource.

14. The method according to claim 13, wherein the resource resolution network is accessible via at least one access network associated with an access device for access to a desired resource.

15. The method according to claim 14, wherein the desired resource is associated with one of the access network and a network external to the access network.

16. The method according to claim 13, wherein the at least one resource resolution node is further adapted to perform a communications decision process to determine a communications mode for access to the resource relative to one or more communications capabilities associated with an access device.

17. The method according to claim 13, wherein the resource identifier is generated by dialing a telephony device.

18. A method for providing access to generalized services over a network comprising the steps of:
(a) associating each of at least one universal shell object with a universal identifier;
(b) associating each of a plurality of users with a plurality of desired services related to a specified universal shell object;
(c) receiving an input universal identifier associated with a desired universal shell object and information associated with a user;
(d) resolving the input universal identifier to determine a desired universal shell object and at least one service, wherein the service is determined as a function of information associated with the user;
(e) providing the at least one service to the user.

19. The method according to claim 18, wherein the universal identifier is disseminated through a distribution channel.

20. The method according to claim 18, wherein the distribution channel includes at least one of an advertisement, an article, a television program, a movie and a commercial product.

21. The method according to claim 1, further including the step of disseminating at least one universal identifier through a distribution channel.

22. The method according to claim 21, wherein the distribution channel includes at least one of an advertisement, an article, a television program, a movie and a commercial product.
